(19) United States
(12) Patent Application Publication
(10) Pub. No.: US 2018/0255304 A1
(43) Pub. Date: Sep. 6, 2018

(54) METHOD AND DEVICE FOR ENCODING/DECODING VIDEO SIGNAL

(71) Applicant: LG ELECTRONICS INC., Seoul (KR)

(72) Inventors: Yongjoon JEON, Seoul (KR); Jin HEO, Seoul (KR); Sunmi YOO, Seoul (KR); Seungwook PARK, Seoul (KR)

(21) Appl. No.: 15/562,304

(22) PCT Filed: Mar. 29, 2016
(86) PCT No.: PCT/KR2016/003190

§ 371 Date: Sep. 27, 2017

Related U.S. Application Data
(60) Provisional application No. 62/139,782, filed on Mar. 29, 2015.
(60) Provisional application No. 62/144,912, filed on Apr. 8, 2015.
(60) Provisional application No. 62/173,976, filed on Jun. 11, 2015.

(51) Int. Cl. H04N 19/159; H04N 19/70; H04N 19/46; H04N 19/176

(52) U.S. Cl. CPC H04N 19/159; H04N 19/176; H04N 19/46; H04N 19/70

(57) ABSTRACT

The present invention provides a method for decoding a video signal, the method comprising the steps of: obtaining, from a video signal, a flip flag for indicating whether a flip of an angle interval is performed when an intra prediction is performed; deriving a flip angle variable according to an intra prediction mode if the flip of the angle interval is performed according to the flip flag when the intra prediction is performed; and generating an intra prediction sample based on the flip angle variable, wherein the angle interval indicates an interval between angle parameters, which indicate a predicting direction.

### TECHNICAL FIELD

The present invention relates to a method and apparatus for encoding/decoding a video signal and, more particularly, to a method and apparatus for performing efficient intra-prediction.

### BACKGROUND ART

Compression encoding means a series of signal processing technologies for transmitting digitalized information through a communication line or storing the digitalized information in a form suitable for a storage medium. Media, such video, an image, and voice, may be the target of compression encoding. In particular, a technology in which compression encoding is performed on video is referred to as video compression.

Next-generation video content will have the characteristics of high spatial resolution, a high frame rate and high dimensionality of scene representation. In order to process such contents, there will be a remarkable increase in terms of memory storage, memory access rate, and processing power.

Therefore, it is necessary to design a coding tool for more efficiently processing next-generation video content.

In particular, in the case of intra-prediction, it is difficult to more precisely predict images of various types due to the setting of a mode having a predetermined precision. Accordingly, it is necessary to perform more efficient intra-prediction so that the image characteristics can be incorporated.

### DISCLOSURE

### Technical Problem

The present invention is to propose a method capable of setting intra angular prediction modes having more directions and precision in performing intra-prediction.

The present invention is to propose a method capable of adaptively setting an intra-prediction mode based on the image characteristics in performing intra-prediction.

The present invention is to propose a method of changing or adjusting the interval between the positions of intra angular prediction modes.

The present invention is to propose a method of weighting a prediction mode in a specific direction corresponding to the image characteristics in performing intra-prediction.

The present invention is to propose a method capable of adaptively selecting at least one of the number of modes and the position of each mode corresponding to an intra angular prediction mode.

The present invention is to propose a method of non-uniformly setting the interval between the positions of intra angular prediction modes.

The present invention is to propose a method of signaling pieces of information for performing the methods.

### Technical Solution

The present invention provides a method of defining an intra angular prediction mode having more directions and precision.

The present invention provides a method capable of adaptively setting an intra-prediction mode based on the image characteristics in performing intra-prediction.

The present invention provides a method of changing or adjusting the interval between the positions of intra angular prediction modes.

The present invention provides a method of weighting a prediction mode in a specific direction corresponding to the image characteristics in performing intra-prediction.

The present invention provides a method capable of adaptively selecting at least one of the number of modes and the position of each mode corresponding to an intra angular prediction mode.

The present invention provides a method of non-uniformly setting the interval between the positions of intra angular prediction modes.

The present invention provides a method of signaling pieces of information for performing the methods.

### Advantageous Effects

The present invention can increase prediction precision and also improve coding efficiency by defining intra angular prediction modes having more directions and precision in intra-prediction coding.

The present invention can perform more adaptive intra-prediction by providing the method of weighting a prediction mode in a specific direction corresponding to the image characteristics in performing intra-prediction and the method of changing or adjusting the interval between the positions of intra angular prediction modes.

The present invention can perform more efficient intra-prediction by adaptively setting an intra-prediction mode based on the image characteristics.

The present invention can perform more adaptive intra-prediction by non-uniformly setting the interval between the positions of intra angular prediction modes.

Furthermore, the present invention can process a video signal more efficiently by decreasing the amount of residual data to be transmitted through the execution of more accurate intra-prediction.

### DESCRIPTION OF DRAWINGS

FIG. 1 is a block diagram illustrating the configuration of an encoder for encoding a video signal according to an embodiment of the present invention.

FIG. 2 is a block diagram illustrating the configuration of a decoder for decoding a video signal according to an embodiment of the present invention.

FIG. 3 is a diagram illustrating the split structure of a coding unit according to an embodiment of the present invention.

FIG. 4 is an embodiment to which the present invention is applied and is a diagram for illustrating a prediction unit.

FIG. 5 is a diagram for describing an intra prediction method, as an embodiment to which the present invention is applied.

FIG. 6 is a diagram for describing a prediction direction according to an intra prediction mode, as an embodiment to which the present invention is applied.

FIG. 7 is another embodiment to which the present invention is applied and is a diagram for illustrating a method of interpolating a reference pixel located in a subpixel.

FIG. 8 is an embodiment to which the present invention is applied and is a diagram for illustrating angle parameters according to intra-prediction modes.

FIG. 9 is an embodiment to which the present invention is applied and is a diagram for illustrating that a mode is adaptively selected if the mode has 1/M precision in an intra-prediction mode.

FIG. 10 is an embodiment to which the present invention is applied and is a schematic block diagram of an encoder that encodes an adaptively selected mode in intra prediction.

FIG. 11 is an embodiment to which the present invention is applied and illustrates a schematic block diagram of a decoder that decodes an adaptively selected mode in intra prediction.

FIGS. 12 to 14 are embodiments to which the present invention is applied, FIGS. 12 and 13 are diagrams for illustrating various intra angular prediction modes according to prediction precision, and FIG. 14 shows that angle parameters corresponding to respective intra angular prediction modes are shown in a table form.

FIG. 15 is an embodiment to which the present invention is applied and shows a method of calculating a prediction sample based on a newly defined intra angular prediction mode.

FIG. 16 is an embodiment to which the present invention is applied and is a diagram for illustrating scan order used in intra-prediction.

FIGS. 17 and 18 are embodiments to which the present invention is applied, FIG. 17 shows a method of allocating scan indices based on a newly defined intra angular prediction mode, and FIG. 18 shows scan indices allocated based on an intra angular prediction mode.

FIGS. 19 to 21 are embodiments to which the present invention is applied and are diagrams for illustrating scan order of coefficients within a TU.

FIG. 22 is an embodiment to which the present invention is applied and is a diagram for illustrating a method of changing the interval between angle parameters.

FIG. 23 is an embodiment to which the present invention is applied and is a diagram for illustrating a method of changing the interval between angle parameters in a 45-degree area unit.

FIG. 24 is an embodiment to which the present invention is applied and is a diagram for illustrating a method of changing the interval between angle parameters in a horizontal/vertical area unit.

FIG. 25 is an embodiment to which the present invention is applied and is a syntax that defines flip flags indicating whether the interval between angle parameters will be changed in a sequence parameter set and a slice header.

FIG. 26 is an embodiment to which the present invention is applied and is a flowchart illustrating a process of performing intra-prediction based on a flip flag.

FIG. 27 is an embodiment to which the present invention is applied and is a flowchart illustrating a process of performing intra-prediction based on a flip flag in a horizontal/vertical area unit.

FIG. 28 is an embodiment to which the present invention is applied and is a diagram for illustrating a method of explicitly transmitting interval information between angle parameters.

FIG. 29 is an embodiment to which the present invention is applied and is a diagram for illustrating a method of explicitly transmitting interval information between angle parameters in a 45-degree area unit.

FIG. 30 is an embodiment to which the present invention is applied and is a diagram for illustrating a method of explicitly transmitting interval information between angle parameters in a horizontal/vertical area unit.

FIG. 31 is an embodiment to which the present invention is applied and is a syntax that defines a method of explicitly transmitting interval information between angle parameters.

FIG. 32 is an embodiment to which the present invention is applied and is a flowchart illustrating a process of performing intra-prediction based on an angle transmission flag.

FIG. 33 is an embodiment to which the present invention is applied and is a flowchart illustrating a process of performing intra-prediction using interval information between angle parameters.

FIG. 34 is an embodiment to which the present invention is applied and is a diagram for illustrating a method of setting intra angular prediction modes at unequal intervals.

### BEST MODE

The present invention provides a method of decoding a video signal, including the steps of obtaining, from the video signal, a flip flag indicating whether the flip of an angle interval is performed when intra-prediction is performed; deriving a flip angle variable based on an intra-prediction mode if the flip of the angle interval is performed according to the flip flag when intra-prediction is performed; and generating an intra-prediction sample based on the flip angle variable, wherein the angle interval represents an interval between angle parameters indicating a prediction direction.

Furthermore, in the present invention, the flip angle variable corresponds to the angle parameter, and the angle parameter indicates a value being set based on the intra-prediction mode.

Furthermore, in the present invention, the flip flag is set in a specific area unit, and the specific area unit indicates a horizontal/vertical area or a 45-degree area.

Furthermore, in the present invention, the flip flag is obtained from at least one of a sequence parameter set, a picture parameter set, a slice, a block, a coding unit and a prediction unit.

Furthermore, the present invention provides a method of decoding a video signal, including the steps of obtaining an angle transmission flag indicating whether the video signal includes prediction angle information indicating an intra-prediction direction; obtaining prediction angle information when the video signal includes the prediction angle information according to the angle transmission flag; deriving an angle parameter based on the prediction angle information; and generating an intra-prediction sample based on the angle parameter, wherein the prediction angle information includes at least one of an angle interval and an angle parameter, and the angle interval indicates an interval between angle parameters which indicate a prediction direction.

Furthermore, in the present invention, the angle transmission flag is set in a specific area unit, and the specific area unit indicates a horizontal/vertical area or a 45-degree area.

Furthermore, in the present invention, when the angle transmission flag has been set in a horizontal/vertical area unit, the angle transmission flag is obtained with respect to both the horizontal area and the vertical area, and the prediction angle information is obtained with respect to at least one of the horizontal area and the vertical area based on the angle transmission flag.

Furthermore, in the present invention, the angle transmission flag is obtained from at least one of a sequence parameter set, a picture parameter set, a slice, a block, a coding unit and a prediction unit.

Furthermore, in the present invention, the prediction angle information is a value at which flip has been performed on the angle interval or the angle parameter.

Furthermore, the present invention provides an apparatus for decoding a video signal, including a parsing unit configured to obtain, from the video signal, a flip flag indicating whether the flip of an angle interval is performed when an intra-prediction is performed; and an intra-prediction unit configured to derive a flip angle variable based on an intra-prediction mode if the flip of an angle interval is performed according to the flip flag when intra-prediction is performed and generate an intra-prediction sample based on the flip angle variable, wherein the angle interval indicates an interval between angle parameters which indicate a prediction direction.

Furthermore, the present invention provides an apparatus for decoding a video signal, including a parsing unit configured to obtain an angle transmission flag indicating whether the video signal comprises prediction angle information indicating an intra-prediction direction; and an intra-prediction unit configured to obtain prediction angle information when the video signal incldues the prediction angle information according to the angle transmission flag, derive an angle parameter based on the prediction angle information, and generate an intra-prediction sample based on the angle parameter, wherein the prediction angle information includes at least one of an angle interval and an angle parameter, and the angle interval indicates an interval between angle parameters which indicate a prediction direction.

### MODE FOR INVENTION

Hereinafter, a configuration and operation of an embodiment of the present invention will be described in detail with reference to the accompanying drawings, a configuration and operation of the present invention described with reference to the drawings are described as an embodiment, and the scope, a core configuration, and operation of the present invention are not limited thereto.

Furthermore, terms used in the present invention are selected from currently widely used general terms, but in a specific case, randomly selected terms by an applicant are used. In such a case, in a detailed description of a corresponding portion, because a meaning thereof is clearly described, the terms should not be simply construed with only a name of terms used in a description of the present invention and a meaning of the corresponding term should be comprehended and construed.

Furthermore, when there is a general term selected for describing the invention or another term having a similar meaning, terms used in the present invention may be replaced for more appropriate interpretation. For example, in each coding process, a signal, data, a sample, a picture, a frame, and a block may be appropriately replaced and construed. Furthermore, in each coding process, partitioning, decomposition, splitting, and division may be appropriately replaced and construed.

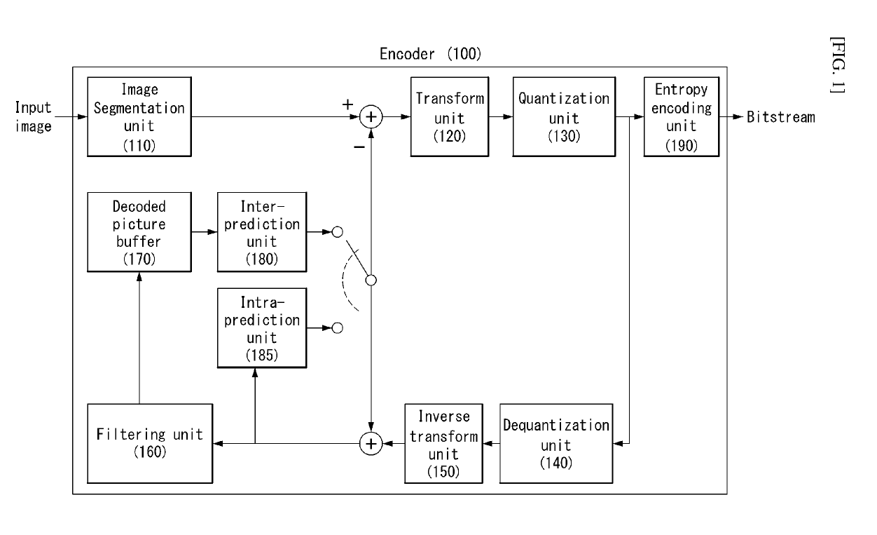

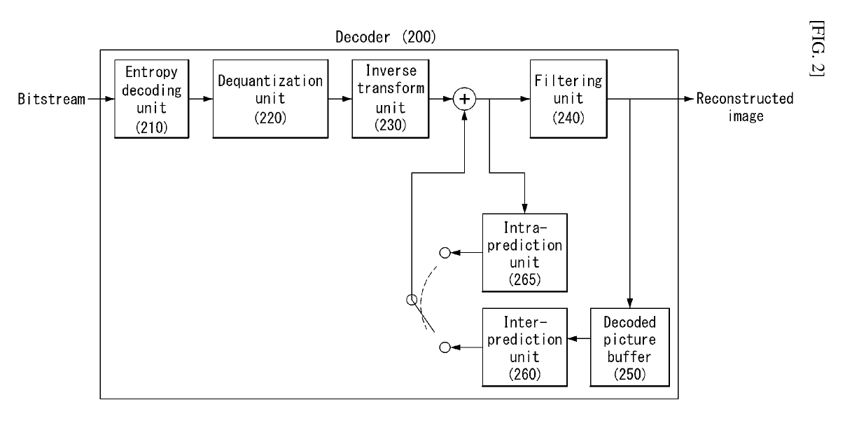

FIG. 1 shows a schematic block diagram of an encoder for encoding a video signal, in accordance with one embodiment of the present invention.

Referring to FIG. 1, an encoder 100 may include an image segmentation unit 110, a transform unit 120, a quantization unit 130, an dequantization unit 140, an inverse transform unit 150, a filtering unit 160, a DPB (Decoded Picture Buffer) 170, an inter-prediction unit 180, an intra-prediction unit 185 and an entropy-encoding unit 190.

The image segmentation unit 110 may divide an input image (or, a picture, a frame) input to the encoder 100 into one or more process units. For example, the process unit may be a coding tree unit (CTU), a coding unit (CU), a prediction unit (PU), or a transform unit (TU).

However, the terms are used only for convenience of illustration of the present disclosure, the present invention is not limited to the definitions of the terms. In this specification, for convenience of illustration, the term “coding unit” is employed as a unit used in a process of encoding or decoding a video signal, however, the present invention is not limited thereto, another process unit may be appropriately selected based on contents of the present disclosure.

The encoder 100 may generate a residual signal by subtracting a prediction signal output from the inter-prediction unit 180 or intra prediction unit 185 from the input image signal. The generated residual signal may be transmitted to the transform unit 120.

The transform unit 120 may apply a transform technique to the residual signal to produce a transform coefficient. The transform process may be applied to a pixel block having the same size of a square, or to a block of a variable size other than a square.

The quantization unit 130 may quantize the transform coefficient and transmits the quantized coefficient to the entropy-encoding unit 190. The entropy-encoding unit 190 may entropy-code the quantized signal and then output the entropy-coded signal as bitstreams.

The quantized signal output from the quantization unit 130 may be used to generate a prediction signal. For example, the quantized signal may be subjected to a dequantization and an inverse transform via the dequantization unit 140 and the inverse transform unit 150 in the loop respectively to reconstruct a residual signal. The reconstructed residual signal may be added to the prediction signal output from the inter-prediction unit 180 or intra-prediction unit 185 to generate a reconstructed signal.

Meanwhile, in the compression process, adjacent blocks may be quantized by different quantization parameters, so that deterioration of the block boundary may occur. This phenomenon is called blocking artifacts. This is one of important factors for evaluating image quality. A filtering process may be performed to reduce such deterioration. Using the filtering process, the blocking deterioration may be eliminated, and, at the same time, an error of a current picture may be reduced, thereby improving the image quality.

The filtering unit 160 may apply filtering to the reconstructed signal and then outputs the filtered reconstructed signal to a reproducing device or the decoded picture buffer 170. The filtered signal transmitted to the decoded picture buffer 170 may be used as a reference picture in the inter-prediction unit 180. In this way, using the filtered picture as the reference picture in the inter-picture prediction mode, not only the picture quality but also the coding efficiency may be improved.

The decoded picture buffer 170 may store the filtered picture for use as the reference picture in the inter-prediction unit 180.

The inter-prediction unit 180 may perform temporal prediction and/or spatial prediction with reference to the reconstructed picture to remove temporal redundancy and/or spatial redundancy. In this case, the reference picture used for the prediction may be a transformed signal obtained via the quantization and dequantization on a block basis in the previous encoding/decoding. Thus, this may result in blocking artifacts or ringing artifacts.

Accordingly, in order to solve the performance degradation due to the discontinuity or quantization of the signal, the inter-prediction unit 180 may interpolate signals between pixels on a subpixel basis using a low-pass filter. In this case, the subpixel may mean a virtual pixel generated by applying an interpolation filter. An integer pixel means an actual pixel existing in the reconstructed picture. The interpolation method may include linear interpolation, bi-linear interpolation and Wiener filter, etc.

The interpolation filter may be applied to the reconstructed picture to improve the precision of the prediction. For example, the inter-prediction unit 180 may apply the interpolation filter to integer pixels to generate interpolated pixels. The inter-prediction unit 180 may perform prediction using an interpolated block composed of the interpolated pixels as a prediction block.

The intra-prediction unit 185 may predict a current block by referring to samples in the vicinity of a block to be encoded currently. The intra-prediction unit 185 may perform a following procedure to perform intra prediction. First, the intra-prediction unit 185 may prepare reference samples needed to generate a prediction signal. Then, the intra-prediction unit 185 may generate the prediction signal using the prepared reference samples. Thereafter, the intra-prediction unit 185 may encode a prediction mode. At this time, reference samples may be prepared through reference sample padding and/or reference sample filtering. Since the reference samples have undergone the prediction and reconstruction process, a quantization error may exist. Therefore, in order to reduce such errors, a reference sample filtering process may be performed for each prediction mode used for intra-prediction.

The intra-prediction unit 185 may predict a current block by referring to samples in the vicinity of a block to be encoded currently. The intra-prediction unit 185 may perform a following procedure to perform intra prediction. First, the intra-prediction unit 185 may prepare reference samples needed to generate a prediction signal. Then, the intra-prediction unit 185 may generate the prediction signal using the prepared reference samples. Thereafter, the intra-prediction unit 185 may encode a prediction mode. At this time, reference samples may be prepared through reference sample padding and/or reference sample filtering. Since the reference samples have undergone the prediction and reconstruction process, a quantization error may exist. Therefore, in order to reduce such errors, a reference sample filtering process may be performed for each prediction mode used for intra-prediction.

The present invention provides a method of defining intra angular prediction modes having more directions and precision in order to increase prediction precision when intra-prediction is performed.

Furthermore, the present invention provides a method capable of adaptively setting an intra-prediction mode based on the image characteristics in performing intra-prediction.

Furthermore, the present invention provides a method of changing or adjusting the interval between the positions of intra angular prediction modes.

Furthermore, the present invention provides a method of weighting a prediction mode in a specific direction corresponding to the image characteristics in performing intra-prediction.

Furthermore, the present invention provides a method capable of adaptively selecting at least one of the number of modes and the position of each mode corresponding to an intra angular prediction mode.

Furthermore, the present invention provides a method of non-uniformly setting the interval between the positions of intra angular prediction modes.

The prediction signal generated via the inter-prediction unit 180 or the intra-prediction unit 185 may be used to generate a reconstructed signal or used to generate a residual signal.

FIG. 2 shows a schematic block diagram of a decoder for decoding a video signal, in accordance with one embodiment of the present invention.

Referring to FIG. 2, a decoder 200 may include a parsing unit (not shown), an entropy decoding unit 210, a dequantization unit 220, an inverse transform unit 230, a filtering unit 240, a decoded picture buffer (DPB) 250, an inter-prediction unit 260 and an intra-prediction unit 265.

A reconstructed video signal output by the decoder 200 may be played back using a playback device.

The decoder 200 may receive a video signal output by the encoder 100 of FIG. 1 and parse syntax elements from the video signal through a parsing unit (not shown). The parsed signal may be entropy-decoded through the entropy decoding unit 210 or may be transmitted to another function unit.

The dequantization unit 220 may obtain transform coefficients from the entropy-decoded signal using quantization step size information.

The inverse transform unit 230 may inverse-transform the transform coefficients to obtain a residual signal.

A reconstructed signal may be generated by adding the obtained residual signal to the prediction signal output by the inter-prediction unit 260 or the intra-prediction unit 265.

The filtering unit 240 may apply filtering to the reconstructed signal and may output the filtered reconstructed signal to the playback device or the decoded picture buffer 250. The filtered signal transmitted to the decoded picture buffer 250 may be used as a reference picture in the inter-prediction unit 260.

In this specification, the embodiments described in the filtering unit 160, inter-prediction unit 180 and intra-prediction unit 185 of the encoder 100 may be equally applied to the filtering unit 240, inter-prediction unit 260 and intra-prediction unit 265 of the decoder, respectively.

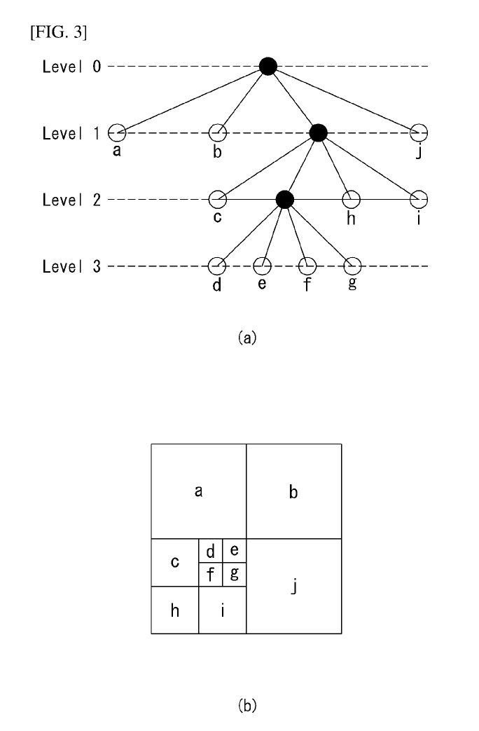

FIG. 3 is a diagram illustrating the split structure of a coding unit according to an embodiment of the present invention.

The encoder may split one video (or picture) in a coding tree unit (CTU) of a quadrangle form. The encoder sequentially encodes by one CTU in raster scan order.

For example, a size of the CTU may be determined to any one of 64×64, 32×32, and 16×16, but the present invention is not limited thereto. The encoder may select and use a size of the CTU according to a resolution of input image or a characteristic of input image. The CTU may include a coding tree block (CTB) of a luma component and a coding tree block (CTB) of two chroma components corresponding thereto.

One CTU may be decomposed in a quadtree (hereinafter, referred to as ‘QT’) structure. For example, one CTU may be split into four units in which a length of each side reduces in a half while having a square form. Decomposition of such a QT structure may be recursively performed.

Referring to FIG. 3, a root node of the QT may be related to the CTU. The QT may be split until arriving at a leaf node, and in this case, the leaf node may be referred to as a coding unit (CU).

The CU may mean a basic unit of a processing process of input image, for example, coding in which intra/inter prediction is performed. The CU may include a coding block (CB) of a luma component and a CB of two chroma components corresponding thereto. For example, a size of the CU may be determined to any one of 64×64, 32×32, 16×16, and 8×8, but the present invention is not limited thereto, and when video is high resolution video, a size of the CU may further increase or may be various sizes.

Referring to FIG. 3, the CTU corresponds to a root node and has a smallest depth (i.e., level 0) value. The CTU may not be split according to a characteristic of input image, and in this case, the CTU corresponds to a CU.

The CTU may be decomposed in a QT form and thus subordinate nodes having a depth of a level 1 may be generated. In a subordinate node having a depth of a level 1, a node (i.e., a leaf node) that is no longer split corresponds to the CU. For example, as shown in FIG. 3B, CU(a), CU(b), and CU(j) corresponding to nodes a, b, and j are split one time in the CTU and have a depth of a level 1.

At least one of nodes having a depth of a level 1 may be again split in a QT form. In a subordinate node having a depth of a level 2, a node (i.e., a leaf node) that is no longer split corresponds to a CU. For example, as shown in FIG. 3B, CU(c), CU(h), and CU(i) corresponding to nodes c, h, and I are split twice in the CTU and have a depth of a level 2.

Furthermore, at least one of nodes having a depth of a level 2 may be again split in a QT form. In a subordinate node having a depth of a level 3, a node (i.e., a leaf node) that is no longer split corresponds to a CU. For example, as shown in FIG. 3B, CU(d), CU(e), CU(f), and CU(g) corresponding to d, e, f, and g are split three times in the CTU and have a depth of a level 3.

The encoder may determine a maximum size or a minimum size of the CU according to an image characteristic (e.g., a resolution) or in consideration of encoding efficiency. Information thereof or information that can derive this may be included in bitstream. A CU having a maximum size may be referred to as a largest coding unit (LCU), and a CU having a minimum size may be referred to as a smallest coding unit (SCU).

Furthermore, the CU having a tree structure may be hierarchically split with predetermined maximum depth information (or maximum level information). Each split CU may have depth information. Because depth information represents the split number and/or a level of the CU, the depth information may include information about a size of the CU.

The size of the SCU may be obtained because the LCU is split in a QT form when the size of the LCU and maximum depth information are used. Alternatively, in contrast, when the size of the SCU and maximum depth information of a tree are used, the size of the LCU may be obtained.

For one CU, information representing whether a corresponding CU is split may be transferred to the decoder. For example, the information may be defined to a split flag and may be represented with “split_cu_flag”. The split flag may be included in the entire CU, except for the SCU. For example, when a value of the split flag is ‘1’, a corresponding CU is again split into four CUs, and when a value of the split flag is ‘0’, a corresponding CU is no longer split and a coding process of the corresponding CU may be performed.

In an embodiment of FIG. 3, a split process of the CU is exemplified, but the above-described QT structure may be applied even to a split process of a transform unit (TU), which is a basic unit that performs transform.

The TU may be hierarchically split in a QT structure from a CU to code. For example, the CU may correspond to a root node of a tree of the transform unit (TU).

Because the TU is split in a QT structure, the TU split from the CU may be again split into a smaller subordinate TU. For example, a size of the TU may be determined to any one of 32×32, 16×16, 8×8, and 4×4, but the present invention is not limited thereto, and when the TU is high resolution video, a size of the TU may increase or may be various sizes.

For one TU, information representing whether a corresponding TU is split may be transferred to the decoder. For example, the information may be defined to a split transform flag and may be represented with a “split_transform_flag”.

The split transform flag may be included in entire TUs, except for a TU of a minimum size. For example, when a value of the split transform flag is ‘1’, a corresponding TU is again split into four TUs, and a value of the split transform flag is ‘0’, a corresponding TU is no longer split.

As described above, the CU is a basic unit of coding that performs intra prediction or inter prediction. In order to more effectively code input image, the CU may be split into a prediction unit (PU).

A PU is a basic unit that generates a prediction block, and a prediction block may be differently generated in a PU unit even within one CU. The PU may be differently split according to whether an intra prediction mode is used or an inter prediction mode is used as a coding mode of the CU to which the PU belongs.

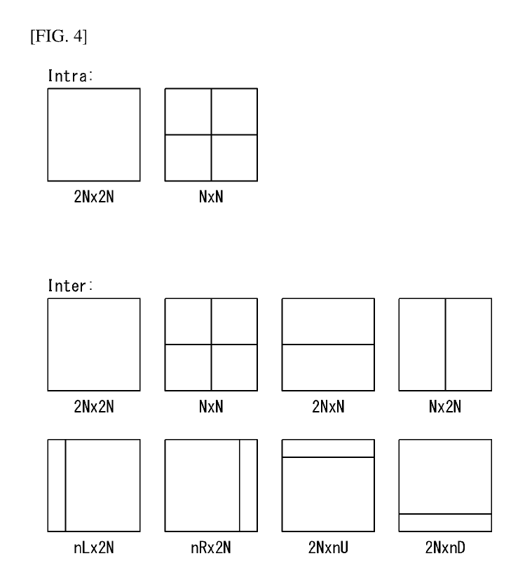

FIG. 4 is an embodiment to which the present invention is applied and is a diagram for illustrating a prediction unit.

A PU is differently split based on whether an intra-prediction mode or an inter-prediction mode is used as the coding mode of a CU to which the PU belongs.

FIG. 4(a) illustrates a PU in the case where the intra-prediction mode is used as the coding mode of a CU to which the PU belongs, and FIG. 4(b) illustrates a PU in the case where the inter-prediction mode is used as the coding mode of a CU to which the PU belongs.

Referring to FIG. 4(a), assuming the case where the size of one CU is 2N×2N (N=4, 8, 16 or 32), one CU may be split into two types (i.e., 2N×2N and N×N).

In this case, if one CU is split as a PU of the 2N×2N form, this means that only one PU is present within one CU.

In contrast, if one CU is split as a PU of the N×N form, one CU is split into four PUs and a different prediction block for each PU is generated. In this case, the partition of the PU may be performed only if the size of a CB for the luma component of a CU is a minimum size (i.e., if the CU is an SCU).

Referring to FIG. 4(b), assuming that the size of one CU is 2N×2N (N=4, 8, 16 or 32), one CU may be split into eight PU types (i.e., 2N×2N, N×N, 2N×N, N×2N, nL×2N, nR×2N, 2N×nU and 2N×nD).

As in intra-prediction, the PU partition of the N×N form may be performed only if the size of a CB for the luma component of a CU is a minimum size (i.e., if the CU is an SCU).

In inter-prediction, the PU partition of the 2N×N form in which a PU is split in a traverse direction and the PU partition of the N×2N form in which a PU is split in a longitudinal direction are supported.

Furthermore, the PU partition of nL×2N, nR×2N, 2N×nU and 2N×nD forms, that is, asymmetric motion partition (AMP) forms, are supported. In this case, ‘n’ means a ¼ value of 2N. However, the AMP cannot be used if a CU to which a PU belongs is a CU of a minimum size.

In order to efficiently code an input image within one CTU, an optimum partition structure of a coding unit (CU), a prediction unit (PU) and a transform unit (TU) may be determined based on a minimum rate-distortion value through the following execution process. For example, an optimum CU partition process within a 64×64 CTU is described. A rate-distortion cost may be calculated through a partition process from a CU of a 64×64 size to a CU of an 8×8 size, and a detailed process thereof is as follows.

1) A partition structure of an optimum PU and TU which generates a minimum rate-distortion value is determined by performing inter/intra-prediction, transform/quantization and inverse quantization/inverse transform and entropy encoding on a CU of a 64×64 size.

2) The 64×64 CU is split into four CUs of a 32×32 size, and an optimum partition structure of a PU and a TU which generates a minimum rate-distortion value for each of the 32×32 CUs is determined.

3) The 32×32 CU is split into four CUs of a 16×16 size again, and an optimum partition structure of a PU and a TU which generates a minimum rate-distortion value for each of the 16×16 CUs is determined.

4) The 16×16 CU is split into four CUs of an 8×8 size again, and an optimum partition structure of a PU and a TU which generates a minimum rate-distortion value for each of the 8×8 CUs is determined.

5) An optimum partition structure of a CU within a 16×16 block is determined by comparing the rate-distortion value of a 16×16 CU calculated in the process 3) with the sum of the rate-distortion values of the four 8×8 CUs calculated in the process 4). This process is performed on the remaining three 16×16 CUs in the same manner.

6) An optimum partition structure of a CU within a 32×32 block is determined by comparing the rate-distortion value of a 32×32 CU calculated in the process 2) with the sum of the rate-distortion values of the four 16×16 CUs calculated in the process 5). This process is performed on the remaining three 32×32 CUs in the same manner.

7) Finally, an optimum partition structure of a CU within a 64×64 block is determined by comparing the rate-distortion value of the 64×64 CU calculated in the process 1) with the sum of the rate-distortion values of the four 32×32 CUs obtained in the process 6).

In the intra-prediction mode, a prediction mode is selected in a PU unit and prediction and a reconfiguration are performed in an actual TU unit with respect to the selected prediction mode.

The TU means a basic unit by which actual prediction and a reconfiguration are performed. The TU includes a transform block (TB) for a luma component and a TB for two chroma components corresponding to the TB for a luma component.

In the example of FIG. 3, as in the case where one CTU is split as a quadtree structure to generate a CU, a TU is hierarchically split as a quadtree structure from one CU to be coded.

The TU is split as a quadtree structure, and thus a TU split from a CU may be split into smaller lower TUs. In HEVC, the size of the TU may be determined to be any one of 32×32, 16×16, 8×8 and 4×4.

Referring back to FIG. 3, it is assumed that the root node of a quadtree is related to a CU. The quadtree is split until a leaf node is reached, and the leaf node corresponds to a TU.

More specifically, a CU corresponds to a root node and has the smallest depth (i.e., depth=0) value. The CU may not be split based on the characteristics of an input image. In this case, a CU corresponds to a TU.

The CU may be split in a quadtree form. As a result, lower nodes of a depth 1 (depth=1) are generated. Furthermore, a node (i.e., leaf node) that belongs to the lower nodes having the depth of 1 and that is no longer split corresponds to a TU. For example, in FIG. 3(b), a TU(a), a TU(b) and a TU(j) corresponding to nodes a, b and j, respectively, have been once split from the CU, and have the depth of 1.

At least any one of the nodes having the depth of 1 may be split in a quadtree form again. As a result, lower nodes having a depth 2 (i.e., depth=2) are generated. Furthermore, a node (i.e., leaf node) that belongs to the lower nodes having the depth of 2 and that is no longer split corresponds to a TU. For example, in FIG. 3(b), a TU(c), a TU(h) and a TU(i) corresponding to nodes c, h and i, respectively, have been twice split from the CU, and have the depth of 2.

Furthermore, at least any one of the nodes having the depth of 2 may be split in a quadtree form again. As a result, lower nodes having a depth 3 (i.e., depth=3) are generated. Furthermore, a node (i.e., leaf node) that belongs to the lower nodes having the depth of 3 and that is no longer split corresponds to a CU. For example, in FIG. 3(b), a TU(d), a TU(e), a TU(f) and a TU(g) corresponding to nodes d, e, f and g, respectively, have been split three times from the CU, and have the depth of 3.

A TU having a tree structure has predetermined maximum depth information (or the greatest level information) and may be hierarchically split. Furthermore, each split TU may have depth information. The depth information may include information about the size of the TU because it indicates the split number and/or degree of the TU.

Regarding one TU, information (e.g., a partition TU flag “split_transform_flag”) indicating whether a corresponding TU is split may be transferred to the decoder. The partition information is included in all of TUs other than a TU of a minimum size. For example, if a value of the flag indicating whether a corresponding TU is split is “1”, the corresponding TU is split into four TUs again. If a value of the flag indicating whether a corresponding TU is split is “0”, the corresponding TU is no longer split.

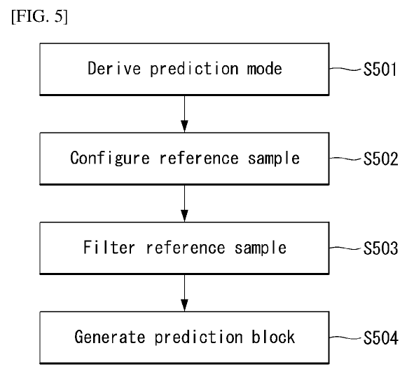

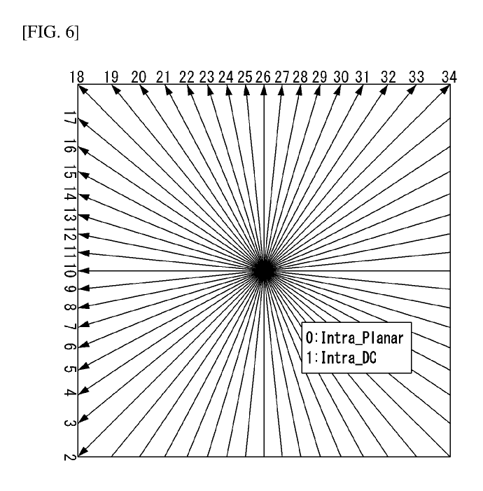

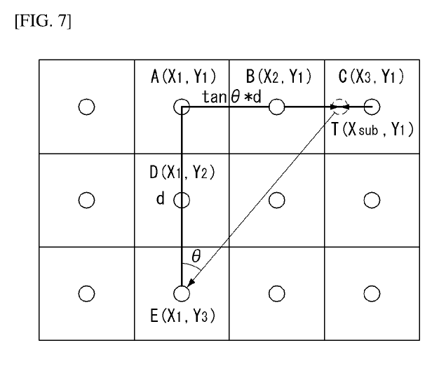

FIGS. 5 to 7 are embodiments to which the present invention is applied, FIG. 5 is a diagram for illustrating an intra-prediction method, FIG. 6 is a diagram for illustrating prediction directions according to intra-prediction modes, and FIG. 7 is a diagram for illustrating a method of interpolating a reference pixel located in a subpixel.

Referring to FIG. 5, the decoder may derive the intra-prediction mode of a current processing block (S501).

In intra-prediction, a prediction direction for the location of a reference sample used for prediction may be included based on a prediction mode. In this specification, an intra-prediction mode having a prediction direction is called an intra angular prediction mode “Intra_Angular prediction mode” or an intra-direction mode. In contrast, an intra-prediction mode not having a prediction direction includes intra planar (INTRA_PLANAR) prediction mode and an intra DC (INTRA_DC) prediction mode.

Table 1 illustrates names associated with the intra-prediction modes, and FIG. 6 illustrates prediction directions according to the intra-prediction modes.

TABLE 1

| INTRA- | |
|---|---|
| PREDICTION MODE | ASSOCIATED NAME |
| 0 | INTRA_PLANAR |
| 1 | INTRA_DC |
| 2 . . . 34 | Intra-direction (INTRA_ANGULAR2 . . . |
| | INTRA_ANGULAR34) |

In intra-prediction, prediction for a current processing block is performed based on a derived prediction mode. The reference sample and detailed prediction method used for prediction are different depending on the prediction mode. If a current block is encoded in the intra-prediction mode, the decoder may derive the prediction mode of the current block in order to perform prediction.

The decoder may check whether neighboring samples of the current processing block can be used for prediction and configure reference samples to be used for the prediction (S502).

In intra-prediction, neighboring samples of a current processing block mean a sample that neighbors the left boundary of the current processing block of an nS×nS size, a total of 2×nS samples that neighbor the bottom left, a sample that neighbors the top boundary of the current processing block, a total of 2×nS samples that neighbor the top right, and a sample that neighbors the top left of the current processing block.

However, some of the neighboring samples of the current processing block may have not been decoded or may not be available. In this case, the decoder may configure the reference samples to be used for prediction by substituting unavailable samples with available samples.

The decoder may filter the reference sample based on an intra-prediction mode (S503).

Whether the filtering is to be performed on the reference sample may be determined based on the size of the current processing block. Furthermore, a method of filtering the reference sample may be determined by a filtering flag transferred by an encoder.

The decoder may generate a prediction block for the current processing block based on the intra-prediction mode and the reference samples (S504). That is, the decoder may generate the prediction block (i.e., generate the prediction sample) for the current processing block based on the intra-prediction mode derived in the intra-prediction mode derivation step S501 and the reference samples obtained through the reference sample configuration step S502 and the reference sample filtering step S503.

If the current processing block is encoded in the INTRA_DC mode, in order to minimize the discontinuity of the boundary between processing blocks, at step S504, the left boundary sample (i.e., a sample neighboring a left boundary within the prediction block) and top boundary sample (i.e., a sample neighboring a top boundary within the prediction block) of the prediction block may be filtered.

Furthermore, at step S504, filtering may be applied to the left boundary sample or the top boundary sample as in the INTRA_DC mode with respect to the vertical mode and horizontal mode of the intra angular prediction modes.

More specifically, if the current processing block has been encoded in the vertical mode or horizontal mode, the value of a prediction sample may be derived based on a reference sample located in a prediction direction. In this case, a boundary sample that belongs to the left boundary sample or top boundary sample of the prediction block and that is not located in the prediction direction may neighbor a reference sample not used for prediction. That is, the distance from the reference sample not used for the prediction may be much shorter than the distance from a reference sample used for the prediction.

Accordingly, the decoder may adaptively apply filtering to left boundary samples or top boundary samples based on whether an intra-prediction direction is the vertical direction or horizontal direction. That is, if the intra-prediction direction is the vertical direction, filtering may be applied to the left boundary samples. If the intra-prediction direction is the horizontal direction, filtering may be applied to the top boundary samples.

Meanwhile, FIG. 7 is a diagram for illustrating a method of interpolating a reference pixel located in a subpixel.

A method used to predict an intra-block using a pixel neighboring a current block may be basically divided into two types of methods, and may be divided into a directional prediction method of configuring a prediction block by copying a reference pixel located in a specific direction and a non-directional prediction method (DC mode, planar mode) of making the best use of a pixel that may be referred.

The directional prediction method has been designed to represent structures in various directions which may appear on a screen. The directional prediction method may be performed by designating a specific direction as a mode and then copying a reference pixel corresponding to a prediction mode angle on the basis of the position of a sample to be predicted. If the reference pixel of an integer pixel unit cannot be referred, however, a prediction block may be configured by copying a pixel interpolated using the distance ratio between two pixels corresponding to each other as in FIG. 7 and two pixels calculated by an angle.

Referring to FIG. 7, a case where a subreference pixel value at a location T (Xsub, Y1) is obtained based on an intra angular prediction mode is assumed.

First, the X coordinates (Xsub) of the subreference pixel T may be obtained according to Equation 1 below.

Xsub=X1+tan θ*d [Equation 1]

In Equation 1, d indicates a distance between a pixel A and a pixel E, and θ indicates an angle according to a prediction direction.

Accordingly, the pixel value of the subreference pixel T may be obtained based on a distance ratio between a pixel B and a pixel C, that is, two neighboring integer pixels. A prediction pixel value corresponding to the pixel E may be determined based on the pixel value of the subreference pixel T.

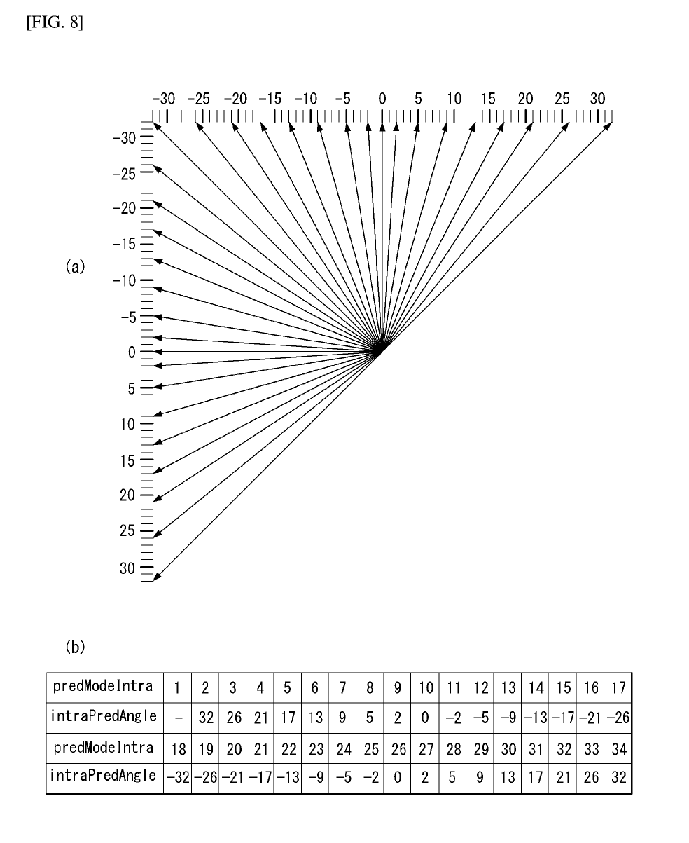

FIG. 8 is an embodiment to which the present invention is applied and is a diagram for illustrating angle parameters according to intra-prediction modes.

FIG. 8(a) shows an intra angular prediction mode, and it may be seen that 8 angles have been defined for each octant based on 1/32 precision.

Furthermore, FIG. 8(b) shows angle parameters according to the intra-prediction modes. The angle parameter means a prediction angle corresponding to an intra-prediction mode and may be indicated as “intraPredAngle.”

A prediction sample may be obtained by projecting the prediction sample onto a reference array depending on an angle of an intra-prediction mode. For example, if intra-prediction modes are 18 or more, a prediction sample may be obtained through Equations 2 to 4 below.

ildx=((y+1)*intraPredAngle)>>5 [Equation 2]

iFact=((y+1)*intraPredAngle)& 31 [Equation 3]

predSamples[x][y]=((32−iFact)*ref[x+ildx+1]+iFact*ref[x+ildx+2]+16)>>5 [Equation 4]

In this case, “ildx” means the position of a neighbor integer sample when the sample is projected onto a reference array. “iFact” means a fraction at the position of the integer sample.

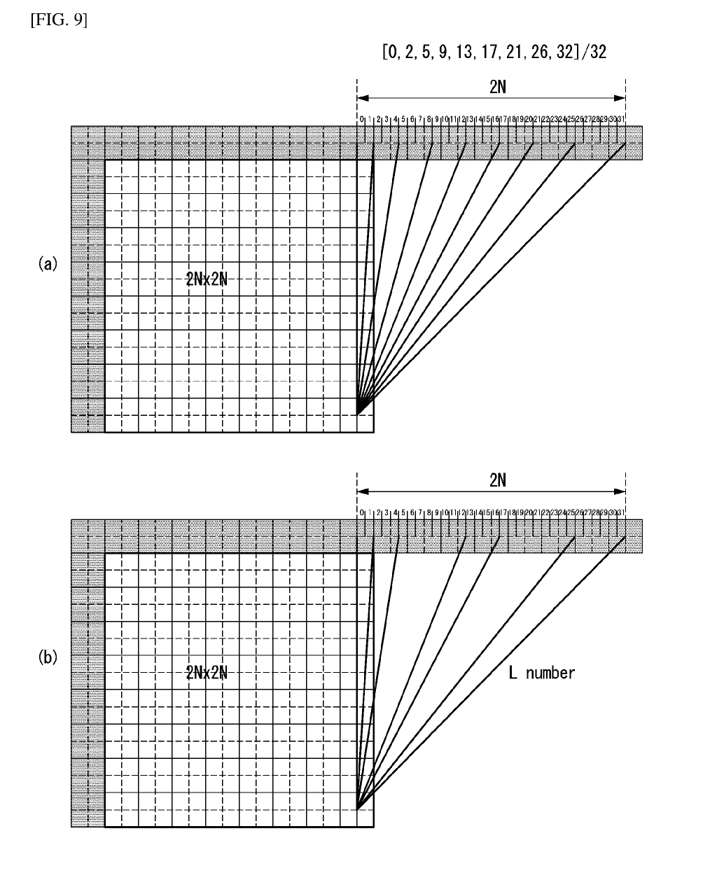

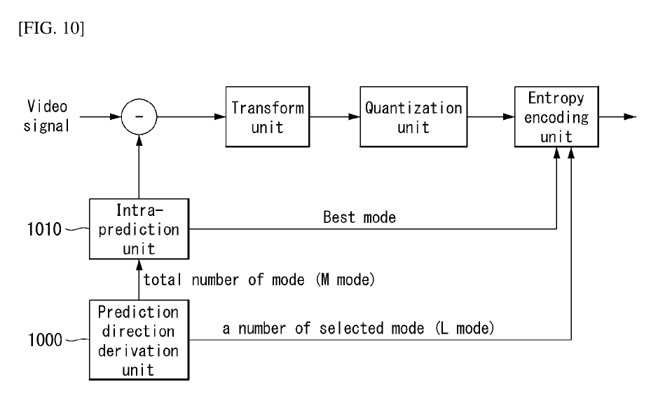

FIG. 9 is an embodiment to which the present invention is applied and is a diagram for illustrating that a mode is adaptively selected if the mode has 1/M precision in an intra-prediction mode.

In intra-prediction, a prediction direction has an angle of +/−[0, 2, 5, 9, 13, 17, 21, 26, 32]/32. The angle indicates a difference between a row under a PU and a reference row over the PU in the case of a vertical mode, and indicates a difference between a column on the top right of a PU and a reference column on the left in the case of a horizontal mode. Furthermore, a pixel is reconstructed using the linear interpolation of top or left reference samples of 1/32 pixel precision.

In the present invention, in intra-prediction, at least one of the number of modes and the position of a mode may be adaptively selected. For example, FIG. 9 is one embodiment to which the present invention is applied. In FIG. 9, the number L of modes corresponding to an angle may be adaptively selected within an area corresponding to 45° on the right in an intra-vertical mode.

FIG. 9(a) shows an example in which in the intra-vertical mode, specific 8 modes having 1/32 precision have been selected with respect to an area 2N corresponding to 45° on the right. FIG. 9(b) shows an example in which in the intra-vertical mode, L modes having 1/M precision (e.g., M=32) have been selected with respect to 2N in an area corresponding to 45° on the right.

The present invention provides a method of adaptively selecting the number L of modes in intra-prediction.

For example, the number L of modes may be differently selected based on the image characteristics of a current block. In this case, the image characteristics of the current block may be checked from surrounding reconstructed samples.

Reference samples (or reference array) used for intra-prediction may be used as the surrounding reconstructed samples. For example, the reference samples may be samples at the positions of p(−1, −2N+1)˜p(−1,−1)˜p(2N−1, −1).

The image characteristics may be determined by a top reference array or a left reference array. In this case, the present invention is not limited to the top or left sample array. For example, two lines of top or left sample arrays or an area of the two lines may be used.

For another example, in the encoder or the decoder to which the present invention is applied, if the image characteristics is determined to be homogeneous, the number L of modes for intra-prediction may be determined to be a minimum.

Furthermore, if the image characteristics are determined to be not homogeneous, the number L of modes for intra-prediction may be determined to have various directional modes.

For example, an edge test, etc. may be used as a method of determining whether the image characteristics are homogeneous or not. If a strong edge is determined to be present in a specific portion when the image is tested, lots of directional modes may be intensively allocated to the portion. Alternatively, in order to determine the image characteristics, various measurement methods, for example, pieces of information, such as the average, distribution, edge strength, and edge direction of pixel values, may be used.

Furthermore, in the present invention, not only the number of modes, but the position of each of L modes having 1/M precision may be adaptively selected.

FIG. 10 is an embodiment to which the present invention is applied and is a schematic block diagram of an encoder that encodes an adaptively selected mode in intra prediction.

The encoder to which the present invention is applied shows the block diagram of the encoder shown in FIG. 1 schematically, and the functions of the parts to which the present invention is applied are focused and described. The encoder may include a prediction direction deriving unit 1000 and an intra prediction unit 1010.

When the encoder performs the intra prediction, the prediction direction deriving unit 1000 may determine a dominant direction based on the information of a neighboring block.

In addition, L modes may be selected based on the dominant direction of the neighboring block. The prediction direction deriving unit 1000 may transmit the selected L modes to an entropy encoding unit, and may transmit the total number M of the intra prediction modes to the intra prediction unit 1010.

The intra prediction unit 1010 may determine an optimal prediction mode among the M intra prediction modes transmitted from the prediction direction deriving unit 1000. The determined optimal prediction mode may be transmitted to the entropy encoding unit.

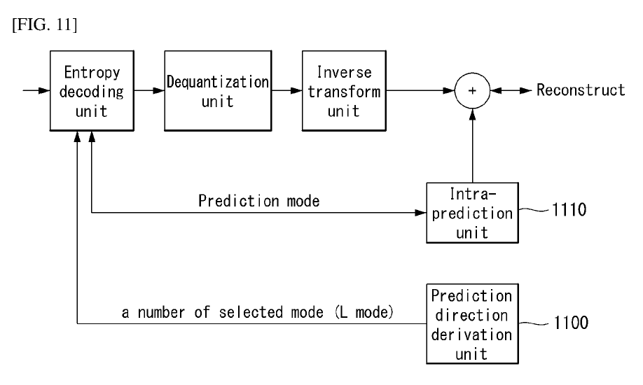

FIG. 11 illustrates a schematic block diagram of a decoder for decoding a mode adaptively selected in the intra prediction, as an embodiment to which the present invention is applied.

The decoder to which the present invention is applied schematically shows the decoder block diagram of FIG. 2, and the functions of the parts to which the present invention is applied are focused and described. The decoder may include a prediction direction deriving unit 1100 and an intra prediction unit 1110.

The prediction direction deriving unit 1100 may transmit the selected L numbers of intra prediction modes to an entropy decoding unit, and the entropy decoding unit may perform an entropy decoding based on the selected mode number L.

In addition, the entropy decoding unit may receive a video signal, and may transmit the intra prediction mode among them to the intra prediction unit 1110.

The intra prediction unit 1110 may perform an intra prediction by receiving the intra prediction mode. The predicted value outputted through the intra prediction may reconstruct the video signal by being added to the residual value passing through the inverse quantization and the inverse transform.

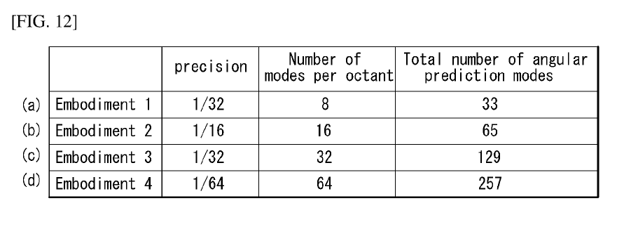

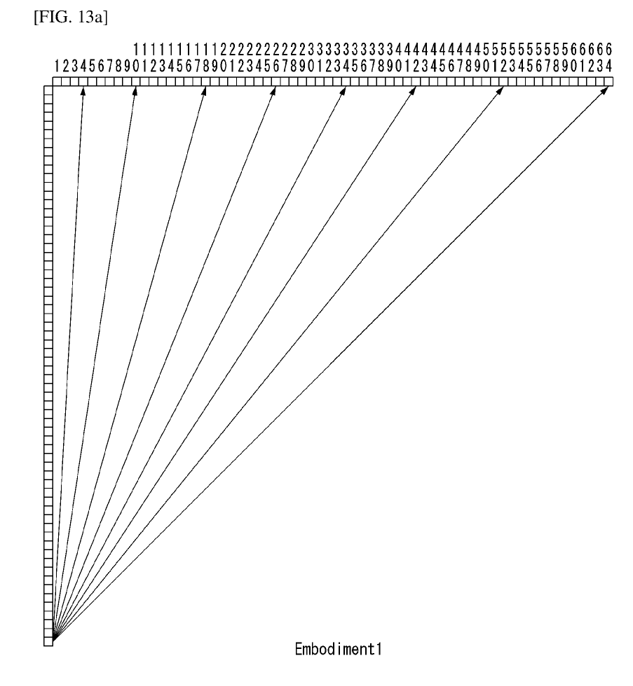

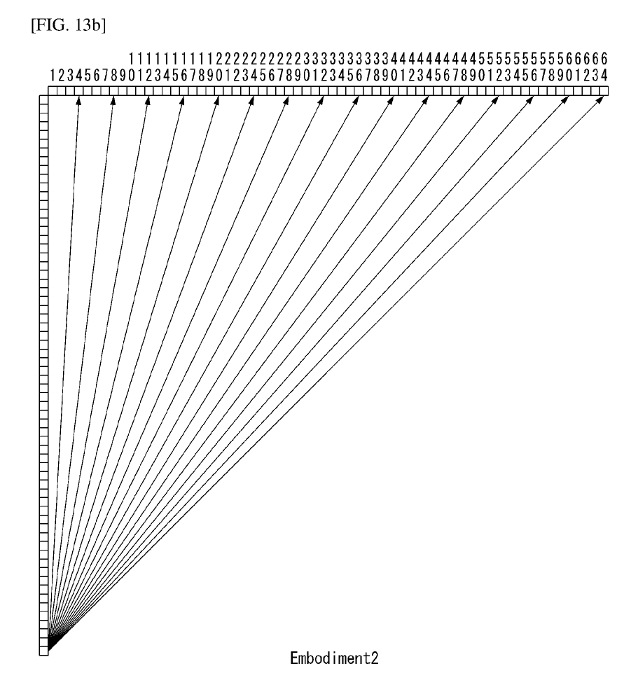

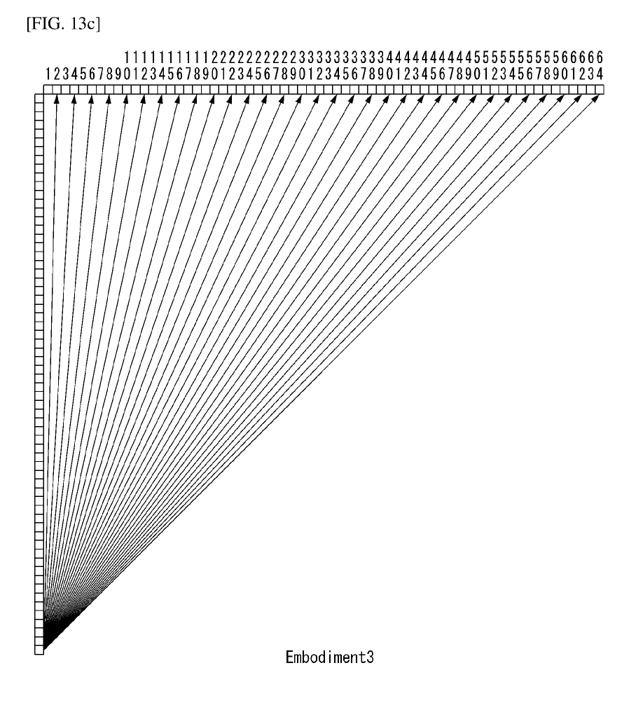

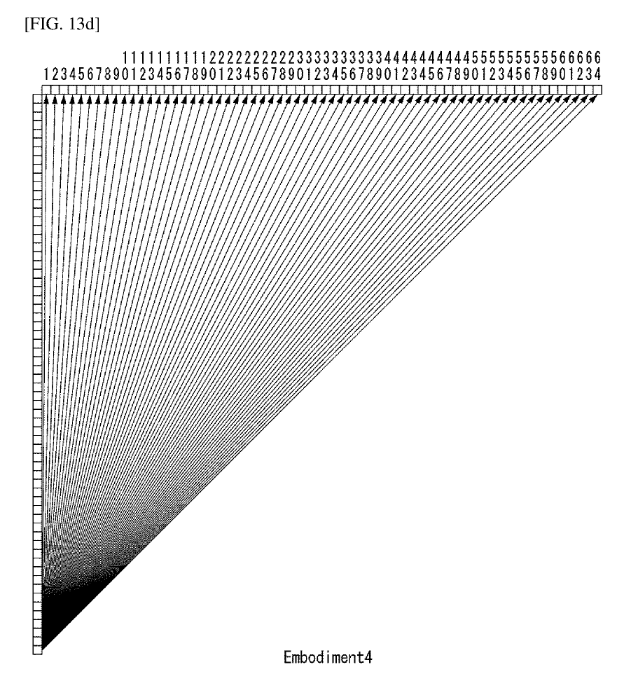

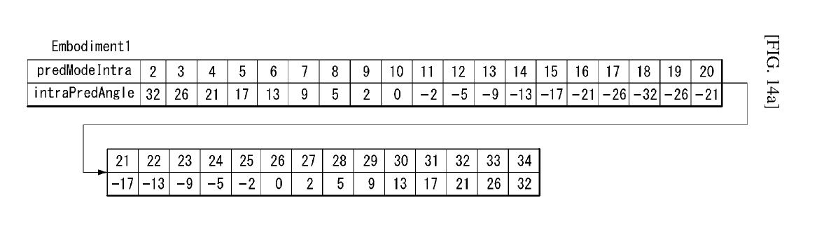

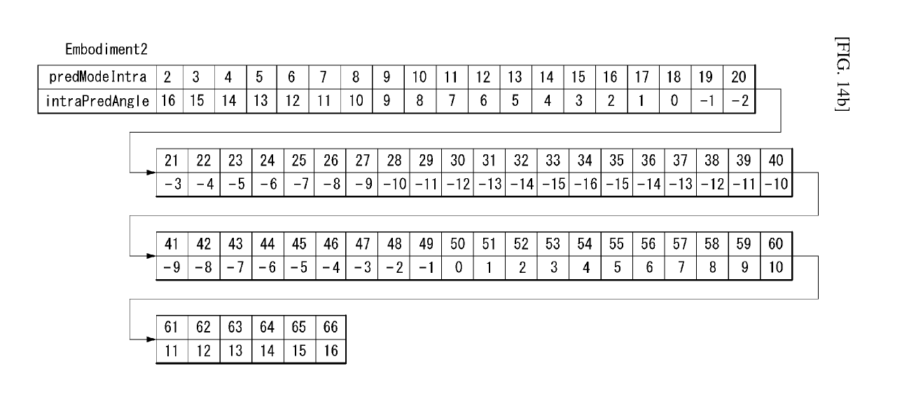

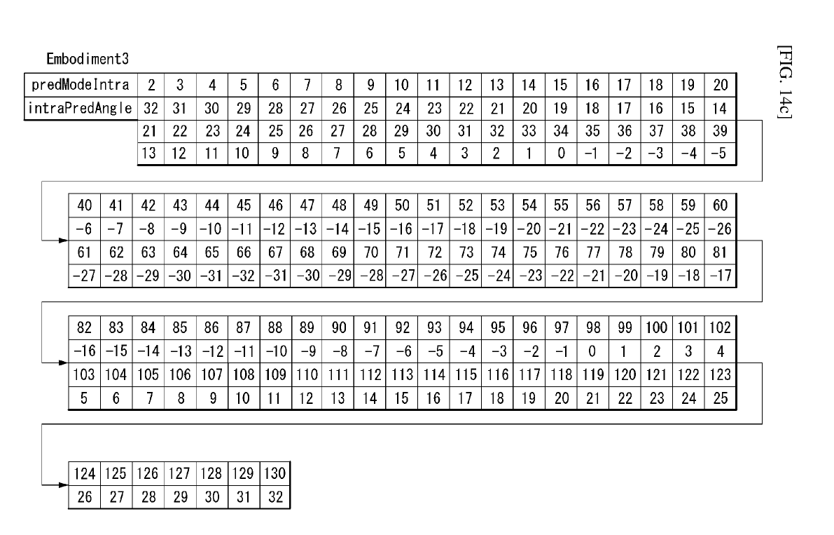

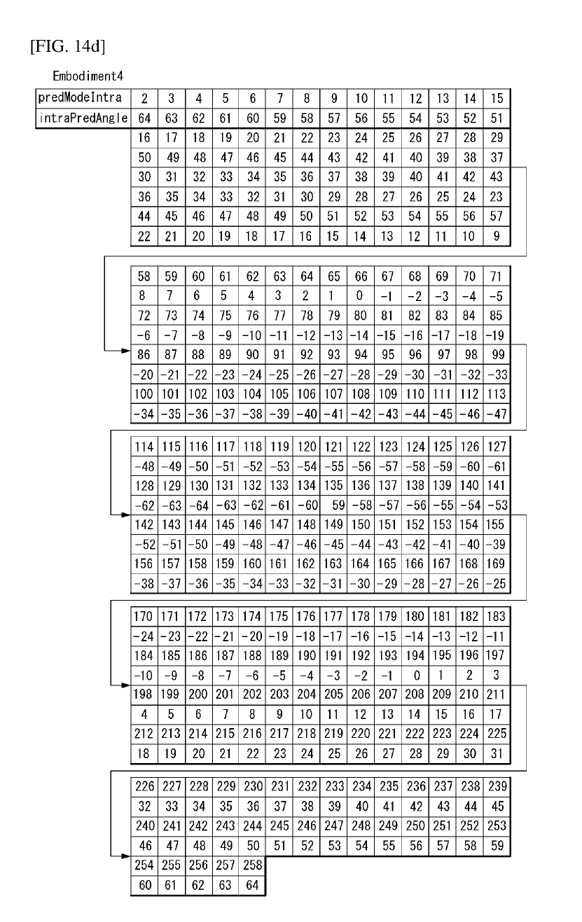

FIGS. 12 to 15 are embodiments to which the present invention is applied, FIGS. 12 and 13 are diagrams for illustrating various intra angular prediction modes according to prediction precision, FIG. 14 shows that angle parameters corresponding to respective intra angular prediction modes are shown in a table form, and FIG. 15 is a method of calculating a prediction sample based on a newly defined intra angular prediction mode.

The present invention provides a method of defining intra angular prediction modes having more directions and precision.

For example, FIGS. 12(a) and 13(a) show a case where an embodiment 1 has 1/32 precision, the number of prediction modes per octant is 8, and a total number of directional prediction modes is 33.

FIGS. 12(b) and 13(b) show a case where an embodiment 2 has 1/16 precision, the number of prediction modes per octant is 16, and a total number of directional prediction modes is 65.

FIGS. 12(c) and 13(c) show a case where an embodiment 3 has 1/32 precision, the number of prediction modes per octant is 32, and a total number of directional prediction modes is 129.

FIGS. 12(d) and 13(d) show a case where an embodiment 4 has 1/64 precision, the number of prediction modes per octant is 64, and a total number of directional prediction modes is 257.

Furthermore, FIGS. 14(a) to 14(d) show corresponding angle parameters “intraPredAngle” in the case of the embodiments 1 to 4, respectively.

Furthermore, FIGS. 15(a) to 15(d) show equations for obtaining prediction samples in the case of the embodiments 1 to 4, respectively.

In this specification, the embodiments 1 to 4 have been illustrated, but the present invention is not limited thereto. Embodiments having different precision and a different number of prediction modes per octant may be additionally defined.

As described above, the present invention can increase prediction precision and can also improve coding efficiency by defining intra angular prediction modes having more directions and precision in intra-prediction coding.

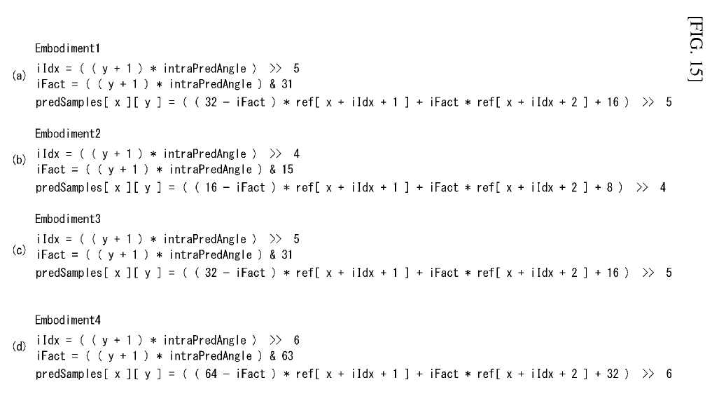

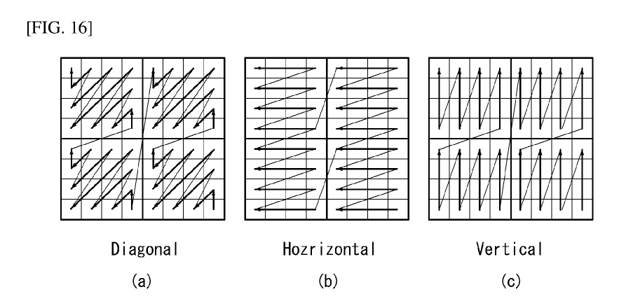

FIG. 16 is an embodiment to which the present invention is applied and is a diagram for illustrating scan order used in intra-prediction.

An intra-coding block has a different scan index “scanldx” based on a prediction mode in a specific block size. FIG. 16 shows diagonal scan order, horizontal scan order and vertical scan order in the case of an 8×8 TU.

For example, the scan index “scanldx” may be defined as follows. If the scan index “scanldx” is 0, it indicates an up-right diagonal scan order. If the scan index “scanldx” is 1, it indicates horizontal scan order. If the scan index “scanldx” is 2, it indicates vertical scan order.

The scan index “scanldx” may be derived based on at least one of a prediction mode and the size of a transform block. For example, the scan index may be derived through the following process.

If a prediction mode is an intra-mode and at least one of the conditions of Table 2 below is true, the scan index “scanldx” may be derived as follows.

TABLE 2

| | |
|---|---|
| (i) | If the size of a current transform block “log2TrafoSize” |
| | is 2 |
| (ii) | If the size of a current transform block “log2TrafoSize” |
| | is 3 and cldx is 0 |
| (iii) | If the size of a current transform block “log2TrafoSize” |
| | is 3 and ChromaArrayType is 3 |

For example, if intra-prediction modes are 6˜14, the scan index “scanldx” may be set to 2. If the intra-prediction modes are 22˜30, the scan index “scanldx” may be set to 1.

In other cases, the scan index “scanldx” may be set to 0.

The present invention is not limited to the above embodiment. If various intra-prediction modes described in this specification are defined, the range to which the intra-prediction mode is applied may be differently set depending on a corresponding embodiment.

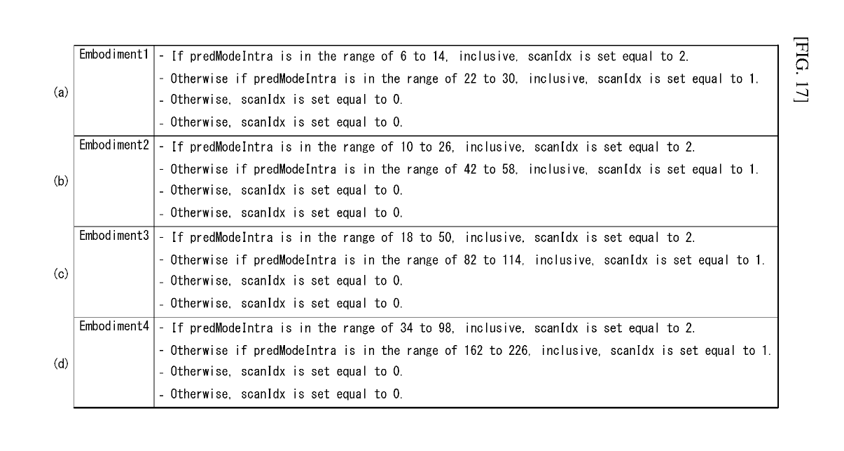

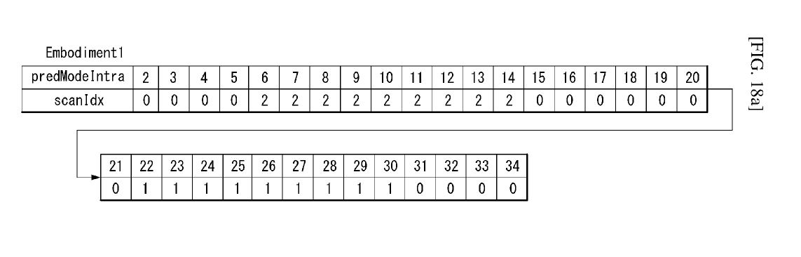

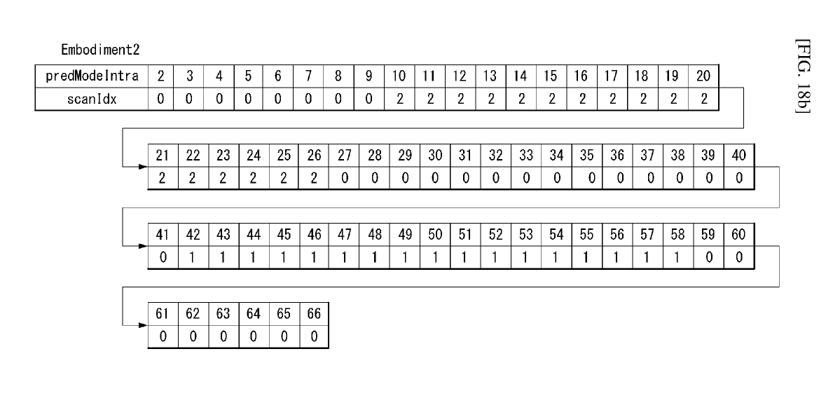

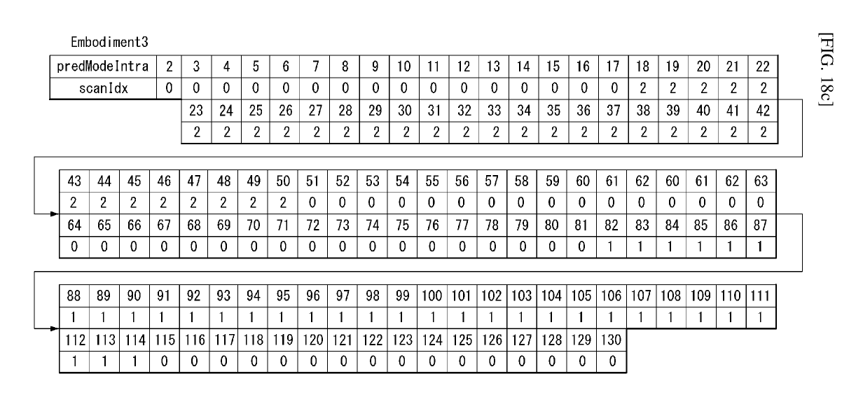

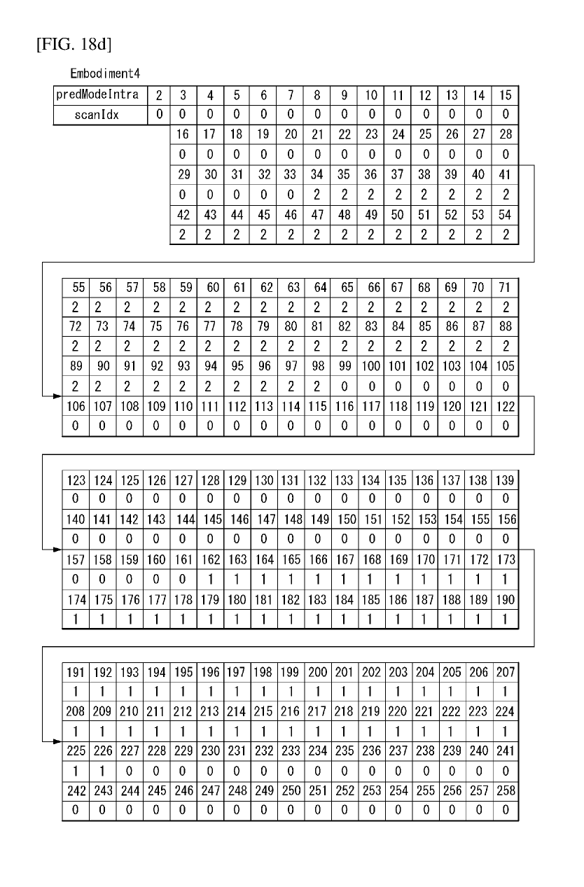

FIGS. 17 and 18 are embodiments to which the present invention is applied, FIG. 17 shows a method of allocating scan indices based on a newly defined intra angular prediction mode, and FIG. 18 shows scan indices allocated based on an intra angular prediction mode.

FIG. 17 shows various embodiments in which a scan index is allocated based on an intra-prediction mode. The embodiments of FIGS. 17 and 18 correspond to the embodiments described with reference to FIGS. 12 to 15, respectively.

The embodiment 1 according to FIG. 17(a) shows a method of allocating a scan index based on an intra-prediction mode if the number of prediction modes per octant is 8 and a total number of directional prediction modes are 33.

If intra-prediction modes are 6˜14, the scan index “scanldx” may be set to 2. If the intra-prediction modes are 22˜30, the scan index “scanldx” may be set to 1. In other cases, the scan index “scanldx” may be set to 0. In this case, if the scan index “scanldx” is 0, it indicates up-right diagonal scan order. If the scan index “scanldx” is 1, it indicates horizontal scan order. If the scan index “scanldx” is 2, it indicates vertical scan order.

The embodiment 2 according to FIG. 17(b) shows a method of allocating a scan index based on an intra-prediction mode if the number of prediction modes per octant is 16 and a total number of directional prediction modes are 65.

If intra-prediction modes are 10˜26, the scan index “scanldx” may be set to 2. If the intra-prediction modes are 42˜58, the scan index “scanldx” may be set to 1. In other cases, the scan index “scanldx” may be set to 0.

The embodiment 3 according to FIG. 17(c) shows a method of allocating a scan index based on an intra-prediction mode if the number of prediction modes per octant is 32 and a total number of directional prediction modes are 129.

If intra-prediction modes are 18˜50, the scan index “scanldx” may be set to 2. If the intra-prediction modes are 82˜114, the scan index “scanldx” may be set to 1. In other cases, the scan index “scanldx” may be set to 0.

The embodiment 4 according to FIG. 17(d) shows a method of allocating a scan index based on an intra-prediction mode if the number of prediction modes per octant is 64 and a total number of directional prediction modes are 257.

If intra-prediction modes are 34˜98, the scan index “scanldx” may be set to 2. If the intra-prediction modes are 162˜226, the scan index “scanldx” may be set to 1. In other cases, the scan index “scanldx” may be set to 0.

Furthermore, FIGS. 18(a) to 18(d) show scan indices “scanldx” corresponding to the embodiments 1 to 4, respectively.

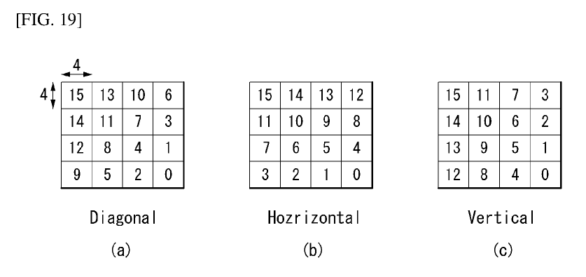

FIGS. 19 to 21 are embodiments to which the present invention is applied and are diagrams for illustrating scan order of coefficients within a TU.

An adaptive coefficient scanning method is necessary because the probability that a distribution of residual signals having directivity may occur increases after intra-prediction even in an 8×8 TU or more as a TU increases.

In the present invention, adaptive scan order is to be defined according to a TU size.

In a first example, a 4×4 subgroup remains intact (maintain scan order within a 4×4 block) and scan order, such as that of FIG. 19, may be used in a 16×16 TU or more. This may be identically extended even in the case of a 32×32 TU and a 64×64 TU.

FIGS. 19(a), 19(b) and 19(c) show that scan order of a 16×16 TU is defined and show diagonal scan order, horizontal scan order and vertical scan order, respectively, in a 4×4 block unit. Scan may be performed based on a number written in the 4×4 block.

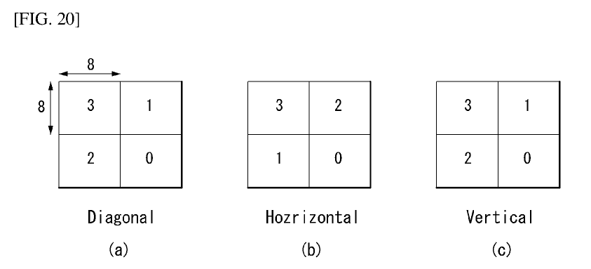

In a second example, a basic subgroup may be extended to be suitable for a TU size. For example, referring to FIG. 20, in a 16×16 TU, the size of a subgroup may be extended to 8×8 and used.

For another example, in a 16×16 TU or more, the size of all of subgroups may be set to 8×8.

For another example, the size of a subgroup may be extended in proportion to a TU size and used. For example, in an 8×8 TU, the size of a subgroup may be set to 4×4, a 16×16 TU may be set to 8×8, and a 32×32 TU may be used as 16×16. FIG. 21 shows that in a 32×32 TU, a subgroup is extended to 16×16 and used.

Furthermore, scan order within a 4×4 block may be used as scan order within a subgroup without any change.

FIG. 22 is an embodiment to which the present invention is applied and is a diagram for illustrating a method of changing the interval between angle parameters.

If intra-prediction is performed, a predictor is generated using surrounding sample values of a current block. The predictor may be generated using an average or weighted average of surrounding samples or may be generated by copying surrounding samples in a specific direction.

In general, a direction within video is weighted in a horizontal direction and vertical direction, but may have a different distribution depending on video content. For example, a direction within video may have been weighted in a diagonal direction.

Accordingly, the present invention provides a method of changing the interval between angle parameters. In this case, the angle parameter means a prediction angle corresponding to an intra-prediction mode and may be represented “intraPredAngle.” The angle parameter may be used to define a direction or represent a location in an intra angular prediction mode.

For example referring to, FIG. 22(a), if the number of prediction modes per octant is 8 and a total number of directional prediction modes is 33 with 1/32 precision, angle parameters corresponding to respective prediction modes may be defined as [0 2 5 9 13 17 21 26 32]. They are also intraPredAngle values corresponding to intra-prediction modes 26˜34 as described with reference to FIG. 14(a).

In this case, the interval between angle parameters becomes [2 3 4 4 4 4 5 6], and this may be seen from FIG. 22(a). Hereinafter, in this specification, the interval between angle parameters is called an angle interval and is also called interval information or a displacement difference according to circumstances.

In an embodiment of the present invention, the direction of a prediction mode may be weight in a different direction by flipping the angle interval.

For example, from FIG. 22(a), it may be seen that the angle interval is [2 3 4 4 4 4 5 6], that is, prediction modes have been weighted in the vertical direction. If the angle interval [2 3 4 4 4 4 5 6] is flipped according to the present invention, the angle interval may be changed like [6 5 4 4 4 4 3 2]. It may be seen that the prediction modes have been weighted in the diagonal direction according to the changed angle interval.

Accordingly, the present invention can perform more accurate prediction by changing predefined prediction modes so that they are weighted in a specific direction based on the image characteristics.

In another embodiment, an angle parameter is not explicitly transmitted, but after a piece of angle interval information is transmitted, the decoder may derive an angle parameter from the transmitted angle interval information.

In another embodiment, information about whether the flip of an angle interval is performed may be defined. For example, assuming that information indicating whether the flip of an angle interval is performed is a flip flag “flip_flag”, if the flip flag is 1, it shows a case where the flip of an angle interval is performed. If the flip flag is 0, it shows a case where the flip of an angle interval is not performed.

Furthermore, the flip flag “flip_flag” may be defined in a horizontal direction and vertical direction unit. For example, the decoder may receive an intra-prediction mode, may check whether the intra-prediction mode is a vertical direction or a horizontal direction, and may check whether flip will be performed on the vertical direction or horizontal direction.

For another example, the flip flag “flip_flag” may be defined for each quarter in a 45-degree unit.

Furthermore, the flip flag “flip_flag” may be defined in at least one level of a sequence parameter set, a picture parameter set, a slice, a block and a coding unit.

In another embodiment, if the flip of an angle interval is not performed, the encoder or the decoder may use a predefined flip table and may derive an angle interval from other information. In this case, the encoder or the decoder may have at least one angle parameter set or angle interval set.

The flip table may be calculated based on precision and an angle parameter set or may be calculated based on an angle interval.

For example, if precision is X and an angle parameter set is [a, b, c, d, e, f, g, h, i], the flip table may be calculated using Equation 5 below.

[X-i,X-h,X-g,X-f,X-e,X-d,X-c,X-b,X-a] [Equation 5]

That is, the flip table may be calculated by inversely subtracting an angle parameter from a value indicating precision. For example, if the angle parameter set is defined as [0, 2, 5, 9, 13, 17, 21, 26, 32], the flip table may be defined as {0, 6, 11, 15, 19, 23, 27, 30, 32}.

Accordingly, a predefined angle parameter set (or angle parameter table) may be used or a flip table may be used based on a flip flag.

FIG. 23 is an embodiment to which the present invention is applied and is a diagram for illustrating a method of changing the interval between angle parameters in a 45-degree area unit.

The present invention can define a flip flag in a specific area unit and perform intra-prediction adaptive to the image characteristics.

In one embodiment, a flip flag may be defined in a 45-degree area unit.

Referring to FIG. 23, whether the flip of an angle interval is performed in a 45-degree area unit may be checked. In this case, a flip flag indicating whether the flip of an angle interval is performed in a 45-degree area unit may be represented as DirQuaterFlip[i] (i=0,1,2,3).

For example, as in FIG. 23(a), if a flip is performed on only the first 45-degree area, it may be configured like DirQuaterFlip[0]=1, DirQuaterFlip[1]=0, DirQuaterFlip[2]=0 and DirQuaterFlip[3]=0. That is, through such configuration, only in the first 45-degree area, prediction modes may be weighted in a diagonal direction.

As in FIG. 23(b), if a flip is performed on only the first and the fourth 45-degree areas, it may be configured like DirQuaterFlip[0]=1, DirQuaterFlip[1]=0, DirQuaterFlip[2]=0 and DirQuaterFlip[3]=1. That is, through such configuration, only in the first 45-degree area and the fourth 45-degree area, prediction modes may be weighted in a diagonal direction.

Meanwhile, the flip flag may be defined in at least one level of a sequence parameter set, a picture parameter set, a slice, a block and a coding unit.

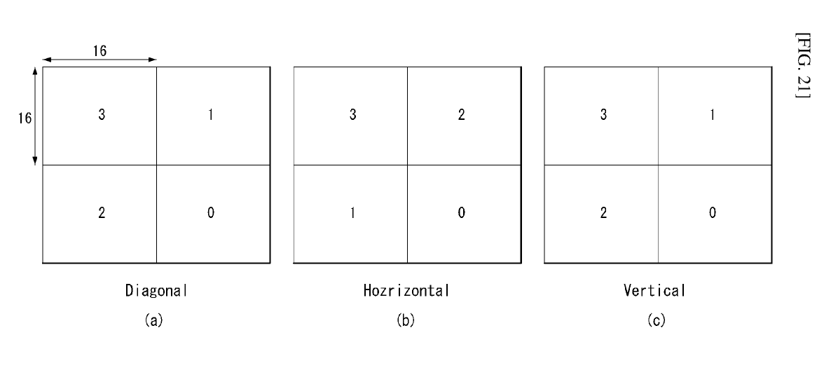

FIG. 24 is an embodiment to which the present invention is applied and is a diagram for illustrating a method of changing the interval between angle parameters in a horizontal/vertical area unit.

The present invention can define a flip flag in a specific area unit and perform intra-prediction adaptive to the image characteristics.

In one embodiment, a flip flag may be defined in a horizontal/vertical area unit.

Referring to FIG. 24, whether the flip of an angle interval is performed in a horizontal/vertical area unit may be checked. In this case, a flip flag indicating whether the flip of an angle interval is performed in a horizontal area and vertical area unit may be represented as DirHorFlip and DirVerFlip.

For example, as in FIG. 24(a), if flip is performed on only a horizontal area, it may be configured like DirHorFlip=1 and DirVerFlip=0. That is, through such configuration, only in the horizontal area, prediction modes may be weighted in a diagonal direction.

As in FIG. 24(b), if flip is performed on a vertical area only, it may be configured like DirHorFlip=0 and DirVerFlip=1. That is, through such configuration, only in the vertical area, prediction modes may be weighted in a diagonal direction.

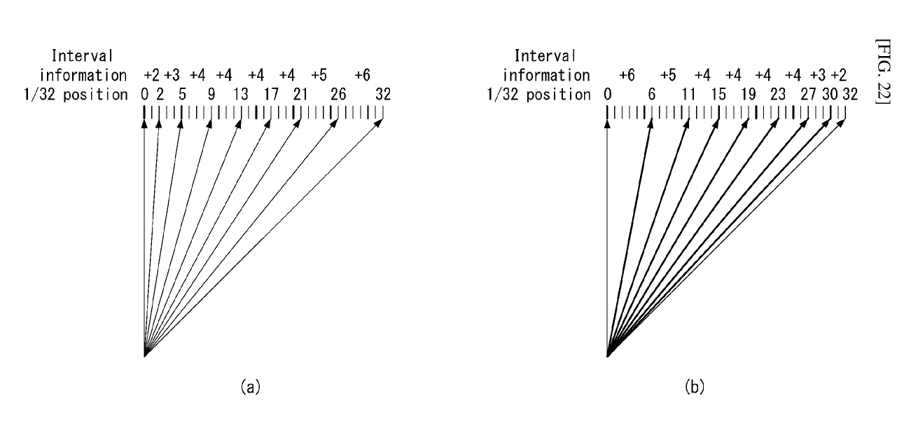

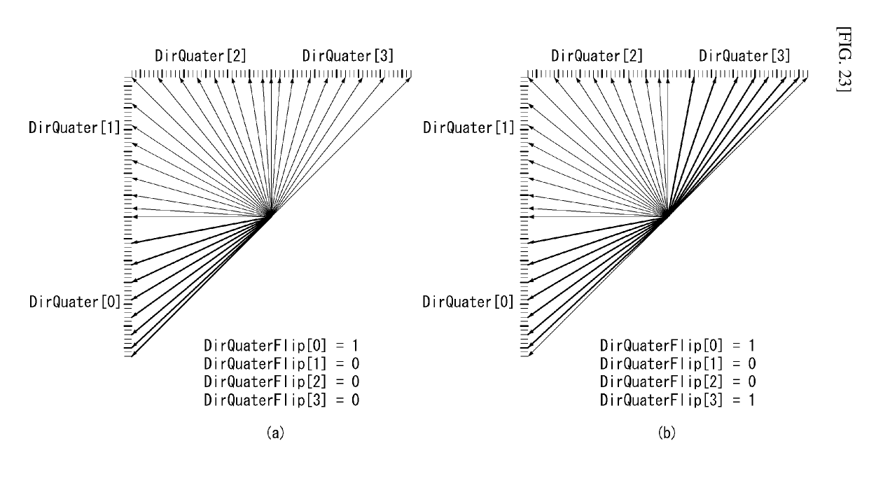

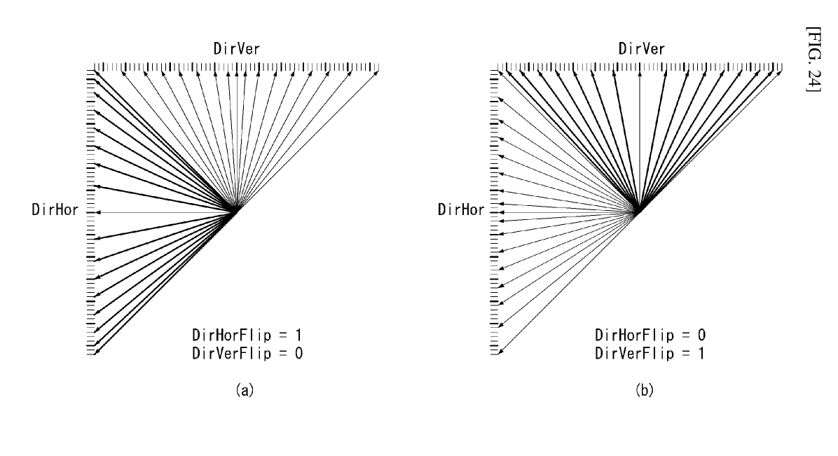

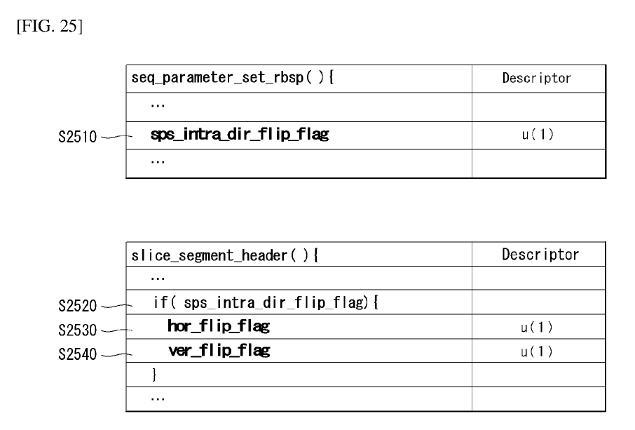

FIG. 25 is an embodiment to which the present invention is applied and is a syntax that defines flip flags indicating whether the interval between angle parameters will be changed in a sequence parameter set and a slice header.

The flip flag may be defined in at least one level of a sequence parameter set, a picture parameter set, a slice, a block and a coding unit.

For example, the flip flag defined in the sequence parameter set may be defined as sps_intra_dir_flip_flag (S2510). In this case, sps_intra_dir_flip_flag may mean whether a sequence performs flip when intra-prediction is performed. If sps_intra_dir_flip_flag=1, it indicates that the sequence performs flip when intra-prediction is performed. If sps_intra_dir_flip_flag=0, it indicates that the sequence does not perform flip when intra-prediction is performed. Furthermore, if sps_intra_dir_flip_flag is not present, it may mean that the sequence does not perform flip when intra-prediction is performed.

For another example, the flip flag defined in the slice may be defined as slice_intra_dir_flip_flag. In this case, slice_intra_dir_flip_flag may be dependent on a flip flag on the upper level. For example, if sps_intra_dir_flip_flag is 1 in a sequence parameter set, slice_intra_dir_flip_flag may be defined (S2520).

The flip flag defined in the slice may be defined in a horizontal/vertical area unit. For example, a flip flag indicating whether the flip of an angle interval is performed in the horizontal area may be called hor_flip_flag (S2530). A flip flag indicating whether the flip of an angle interval is performed in the vertical area may be called ver_flip_flag (S2540). In this case, hor_flip_flag and ver_flip_flag may be examples of slice_intra_dir_flip_flag.

For example, if hor_flip_flag is 1, the flip of an angle interval is performed on when intra-prediction modes are 2˜17. If hor_flip_flag is 0, the flip of an angle interval is not performed when the intra-prediction modes are 2˜17.

Furthermore, if ver_flip_flag is 1, the flip of an angle interval is performed when intra-prediction modes are 18˜34. If ver_flip_flag is 0, the flip of an angle interval is not performed when the intra-prediction modes are 18˜34.

Another embodiment of the present invention provides a method of obtaining a prediction sample based on a flip flag.

First, it is assumed that an intra-prediction flip parameter is isIntraAngleFlip. If sps_intra_dir_flip_flag=1, isIntraAngleFlip may be defined as in Equation 6 below.

isIntraAngleFlip=ver_flip_flag==1?2+hor_flip_flag:hor_flip_flag [Equation 6]

If ver_flip_flag is 1, isIntraAngleFlip may be set as “2+hor_flip_flag.”. If ver_flip_flag is not 1, isIntraAngleFlip may be set as a hor_flip_flag value.

The isIntraAngleFlip may be used as an input value for obtaining a prediction sample.

Furthermore, the present invention can define a parameter intraFlip indicative of a flip for a horizontal or vertical direction and may obtain a prediction sample based on the intraFlip.

First, if the intraFlip is greater than 0, an angle parameter “intraPredAngle” may be defined as follows.

1. absIntraPredAngle may be set as Abs “intraPredAngle.”

2. The mapping table between absIntraPredAngle and the flip angle variable “flipintraPredAngle” may be defined as in Table 3.

TABLE 3

| | absIntraPredAngle | | | | | | | | |
|---|---|---|---|---|---|---|---|---|---|
| | 0 | 2 | 5 | 9 | 13 | 17 | 21 | 26 | 32 |
| flipIntraPredAngle | 0 | 6 | 11 | 15 | 19 | 23 | 27 | 30 | 32 |

3. If intraFlip is 1, intraPredAngle may be defined as follows.
If the intra-prediction mode “predModeIntra” is greater than 1 and smaller than 18 and intraPredAngle is greater than 0, intraPredAngle=flipintraPredAngle may be set.
Otherwise, if the intra-prediction mode “predModeIntra” is greater than 1 and smaller than 18 and intraPredAngle is smaller than 0, intraPredAngle=(−) flipintraPredAngle may be set.
Otherwise, if intraFlip is 2, intraPredAngle may be defined as follows.

(i) If the intra-prediction mode “predModeIntra” is greater than 18 and intraPredAngle is greater than 0, intraPredAngle=flipintraPredAngle may be set.

(ii) Otherwise, if the intra-prediction mode “predModeIntra” is greater than 8 and intraPredAngle is smaller than 0, intraPredAngle=(−)flipintraPredAngle may be set.
Otherwise, if intraFlip is 3, intraPredAngle may be defined as follows.

(i) If intraPredAngle is greater than 0, intraPredAngle=flipintraPredAngle may be set.

(ii) Otherwise, if intraPredAngle is smaller than 0, intraPredAngle=(−) flipIntraPredAngle may be set.

4. If the intra-prediction mode “predModeIntra” is greater than 10 and smaller than 26, invAngle may be set as 256*32/intraPredAngle.

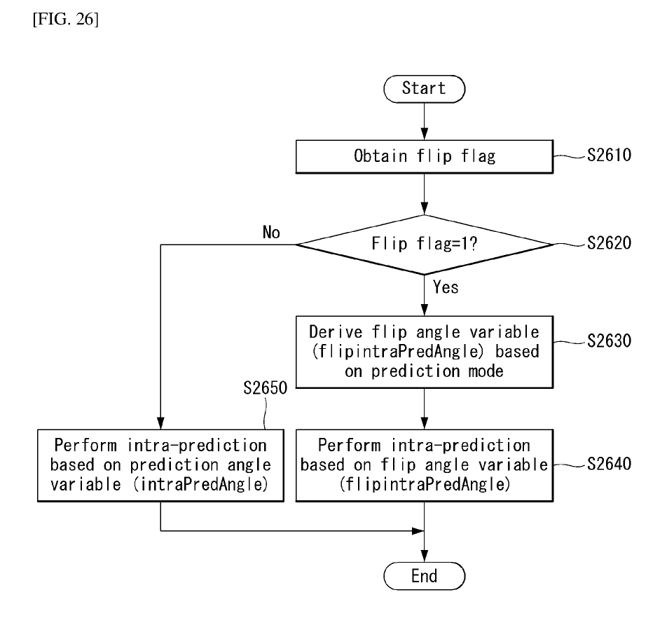

FIG. 26 is an embodiment to which the present invention is applied and is a flowchart illustrating a process of performing intra-prediction based on a flip flag.

First, the decoder may obtain a flip flag from a received video signal (S2610). The flip flag may mean whether flip is performed when intra-prediction and may be defined in various levels within the video signal. For example, the flip flag may be defined in at least one level of a sequence parameter set, a picture parameter set, a slice, a block and a coding unit.

Furthermore, the decoder may check whether the flip flag is 1 (S2620). If, as a result of the check, the flip flag is 1, this indicates that flip is performed when intra-prediction is performed. If the flip flag is 0, this indicates that flip is not performed when intra-prediction is performed. Furthermore, if the flip flag is not present, this may mean that flip is not performed when intra-prediction is performed.

If the flip flag is 1, the decoder may derive a flip angle variable “flipintraPredAngle” based on a prediction mode (S2630). The flip angle variable “flipintraPredAngle” may be defined as a value corresponding to the angle parameter “intraPredAngle” as in Table 3. In this case, the angle parameter “intraPredAngle” may be a value set based on a prediction mode.

Furthermore, the decoder may perform intra-prediction based on the flip angle variable “flipintraPredAngle.” (S2640).

Meanwhile, if as a result of the check at step S2620, the flip flag is 0, the decoder may perform intra-prediction based on the angle parameter “intraPredAngle.” (S2650). For example, the angle parameter “intraPredAngle” may be set as a value corresponding to an intra-prediction mode as described with reference to FIG. 14.

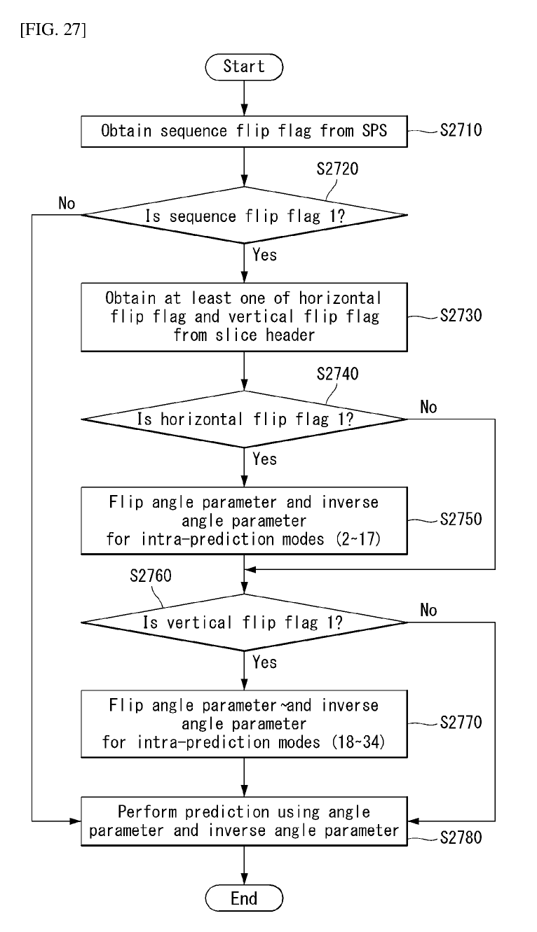

FIG. 27 is an embodiment to which the present invention is applied and is a flowchart illustrating a process of performing intra-prediction based on a flip flag in a horizontal/vertical area unit.

First, the decoder may obtain a sequence flip flag from a sequence parameter set (S2710). In this case, the sequence flip flag may mean whether the sequence performs flip when intra-prediction is performed and may be expressed as sps_intra_dir_flip_flag. If sps_intra_dir_flip_flag=1, it indicates that the sequence performs flip when intra-prediction is performed. If sps_intra_dir_flip_flag=0, it indicates that the sequence does not perform flip when intra-prediction is performed. Furthermore, if sps_intra_dir_flip_flag is not present, this may mean that the sequence does not perform flip when intra-prediction is performed.

The decoder may check whether the sequence flip flag “sps_intra_dir_flip_flag” is 1 (S2720).

If the sequence flip flag “sps_intra_dir_flip_flag” is 1, the decoder may obtain at least one of a horizontal flip flag and a vertical flip flag from a slice header (S2730).

In this case, the horizontal flip flag indicates whether the flip of an angle interval is performed in a horizontal area and may be expressed as hor_flip_flag. Furthermore, the vertical flip flag indicates whether the flip of an angle interval is performed in a vertical area and may be expressed as ver_flip_flag.

In contrast, if the sequence flip flag “sps_intra_dir_flip_flag” is 0, the sequence does not perform flip when intra-prediction is performed. Accordingly, the decoder may perform intra-prediction using at least one of an angle parameter and an inverse angle parameter (S2780).

The decoder may check whether the horizontal flip flag “hor_flip_flag” is 1 (S2740).

If the horizontal flip flag “hor_flip_flag” is 1, the decoder perform the flip of an angle interval if intra-prediction modes are 2˜17. For example, the decoder may perform flip on at least one of an angle parameter and an inverse angle parameter (S2750).

Furthermore, the decoder may check whether the vertical flip flag “ver_flip_flag” is 1 (S2760).

If the vertical flip flag “ver_flip_flag” is 1, the decoder performs the flip of an angle interval if intra-prediction modes are 18˜34. For example, the decoder may perform flip on at least one of an angle parameter and an inverse angle parameter (S2770).

The decoder may perform intra-prediction using at least one of the flipped angle parameter and the flipped inverse angle parameter (S2780).

In contrast, if the horizontal flip flag “hor_flip_flag” is 0, the decoder does not perform the flip of an angle interval when intra-prediction modes are 2˜17, and may check whether the vertical flip flag “ver_flip_flag” is 1.

If, as a result of the check, the vertical flip flag “ver_flip_flag” is 0, the decoder does not perform the flip of an angle interval when intra-prediction modes are 18˜34. Accordingly, the decoder may perform intra-prediction using at least one of an angle parameter and an inverse angle parameter.

In the present embodiment, the horizontal/vertical flip flags of a sequence flip flag and a slice level have been illustrated, but the present invention is not limited thereto and may be described using terms “first flip flag and second flip flag.” In this case, the second flip flag may mean whether flip is performed in a level lower than that of the first flip flag. For example, if the sequence flip flag is defined as the first flip flag, the second flip flag may mean whether flip is performed when intra-prediction is performed in a slice level. As described above, the first flip flag, the second flip flag, the third flip flag, etc. may be used in at least one level of a sequence parameter set, a picture parameter set, a slice, a block and a prediction unit.

FIG. 28 is an embodiment to which the present invention is applied and is a diagram for illustrating a method of explicitly transmitting interval information between angle parameters.

The present invention provides a method of changing the interval between angle parameters and signaling the changed interval. In this case, the angle parameter means a prediction angle corresponding to an intra-prediction mode and may be expressed as “intraPredAngle.” The angle parameter may be used to define a direction or indicate a position in an intra angular prediction mode.

For example, referring to FIG. 28(a), if the number of prediction modes per octant is 8 and a total number of directional prediction modes is 33 with 1/32 precision, angle parameters corresponding to respective prediction modes may be defined as [0 2 5 9 13 17 21 26 32]. As described with reference to FIG. 14(a), they are intraPredAngle values corresponding to intra-prediction modes 26˜34.

In this case, the interval between angle parameters become [2 3 4 4 4 4 5 6] and may be seen from FIG. 28(a).

In an embodiment of the present invention, as described above, the direction of a predefined prediction mode may be weighted in a different direction by flipping an angle interval.

For example, in the case of FIG. 28(a) if an angle interval is [2 3 4 4 4 4 5 6], that is, it may be seen that prediction modes have been weight in the vertical direction. If the angle interval [2 3 4 4 4 4 5 6] according to the present invention is flipped, the angle interval may be changed like [6 5 4 4 4 4 3 2]. It may be seen that prediction modes have been weighted in a diagonal direction according to the changed angle interval.

The present invention proposes a method of transmitting a changed angle interval through signaling as described above. The changed angle interval may be transmitted in at least one of a sequence parameter set, a picture parameter set, a slice, a block, an LCU, a CU and a PU.

For example, referring to FIG. 28(b), the changed angle interval [6 5 4 4 4 4 3 2] may be signaled and may be transmitted in at least one level of a sequence parameter set, a picture parameter set, a slice, a block, an LCU, a CU and a PU.

The decoder may receive a changed angle interval, may configure an intra-prediction mode and may perform intra-prediction based on the intra-prediction mode.

FIG. 29 is an embodiment to which the present invention is applied and is a diagram for illustrating a method of explicitly transmitting interval information between angle parameters in a 45-degree area unit.

The present invention can define an angle transmission flag in a specific area unit and perform adaptive intra-prediction by transmitting at least one of an angle interval and an angle parameter in the specific area unit.

In this case, the angle transmission flag indicates whether prediction angle information is transmitted or not and may be expressed as explicit_angle_flag. The prediction angle information is information indicating an intra-prediction direction and may include at least one of an angle interval and an angle parameter. For example, if explicit_angle_flag is 1, it indicates that prediction angle information is transmitted. If explicit_angle_flag is 0, it indicates that prediction angle information is not transmitted. Furthermore, if explicit_angle_flag is not present, it indicates that prediction angle information is not transmitted.

For another example, if the flip of a prediction angle is performed, the prediction angle information may include at least one of a flipped angle interval and a flipped angle parameter.

In one embodiment, an angle transmission flag may be defined in a 45-degree area unit and at least one of an angle interval and an angle parameter may be transmitted in a 45-degree area unit.

From FIG. 29, it may be seen whether prediction angle information is transmitted or not in a 45-degree area unit. In this case, an angle transmission flag indicting whether prediction angle information is transmitted or not in a 45-degree area unit may be expressed ExplicitDirQuaterFlag[i] (i=0, 1, 2, 3), and a transmitted angle interval may be expressed as DiffDispVal[i] (i=0, 1, 2, 3).

For example, as in FIG. 29(a), if prediction angle information is transmitted only in a first 45-degree area, it may be configured as in Equation 7.

ExplicitDirQuaterFlag[0]=1,DiffDispVal[0]=[3,4,4,5,6,5,3,2]

ExplicitDirQuaterFlag[1]=0,DiffDispVal[1]=[ ]

ExplicitDirQuaterFlag[2]=0,DiffDispVal[2]=[ ]

ExplicitDirQuaterFlag[3]=0,DiffDispVal[3]=[ ] [Equation 7]

That is, through such configuration, prediction modes may be weighted in a diagonal direction only in the first 45-degree area, and only the angle interval of the first 45-degree area may be transmitted.

In another embodiment, as in FIG. 29(b), if prediction angle information is transmitted only in the first and the third 45-degree areas, it may be configured as in Equation 8.

ExplicitDirQuaterFlag[0]=1,DiffDispVal[0]=[3,4,4,5,6,5,3,2]

ExplicitDirQuaterFlag[1]=0,DiffDispVal[1]=[ ]

ExplicitDirQuaterFlag[2]=1,DiffDispVal[2]=[3,3,3,7,7,3,3,3]

ExplicitDirQuaterFlag[3]=0,DiffDispVal[3]=[ ] [Equation 8]

That is, through such configuration, in the first 45-degree area, prediction modes may be weighted in the diagonal direction, and in the third 45-degree area, prediction modes may be weighted in the diagonal direction and the vertical direction. Furthermore, the angle interval of the first 45-degree area and the angle interval of the third 45-degree area may be transmitted.

Meanwhile, the flip flag may be defined in at least one level of a sequence parameter set, a picture parameter set, a slice, a block and a coding unit.

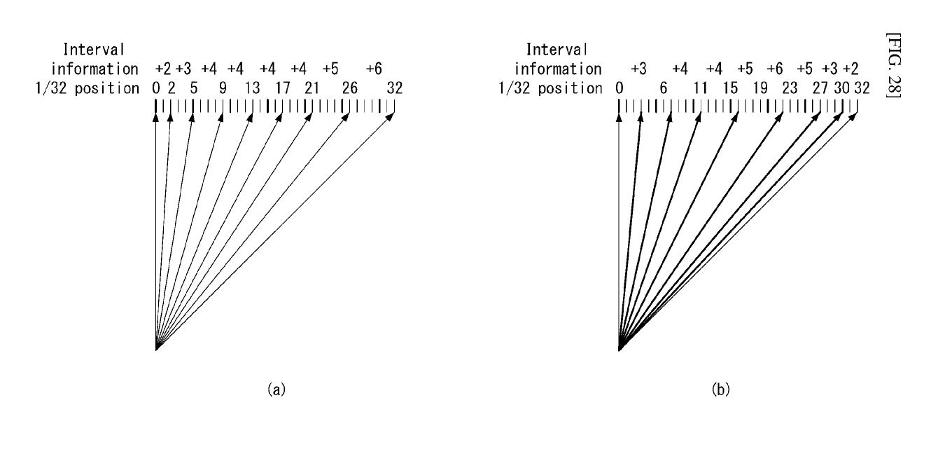

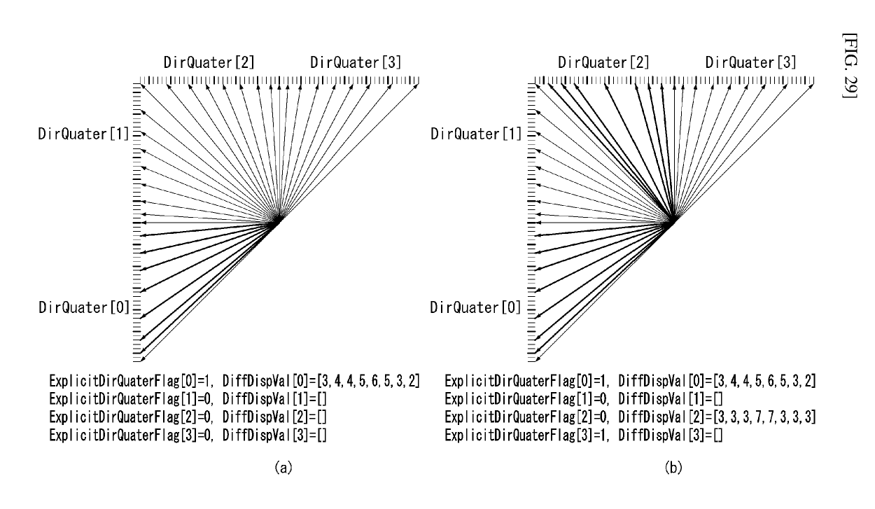

FIG. 30 is an embodiment to which the present invention is applied and is a diagram for illustrating a method of explicitly transmitting interval information between angle parameters in a horizontal/vertical area unit.

The present invention can define an angle transmission flag in a specific area unit and perform adaptive intra-prediction by transmitting at least one of an angle interval and an angle parameter in the specific area unit.

In this case, the angle transmission flag may indicate whether prediction angle information is transmitted or not and may be expressed as explicit_angle_flag. The prediction angle information is information indicating an intra-prediction direction and may include at least one of an angle interval and an angle parameter.

For another example, if the flip of a prediction angle is performed, the prediction angle information may include at least one of a flipped angle interval and a flipped angle parameter.

In one embodiment, an angle transmission flag may be defined in a horizontal/vertical area unit and at least one of an angle interval and an angle parameter may be transmitted in a horizontal/vertical area unit.

From FIG. 30, it may be seen whether prediction angle information is transmitted in a horizontal/vertical area unit. In this case, angle transmission flags indicating whether prediction angle information is transmitted in a horizontal/vertical area unit may be expressed as ExplicitDirHorFlag and ExplicitDirVerFlag, respectively. Transmitted prediction angle information may be expressed as DiffDispVal[i] (i=0,1,2,3).

For example, as FIG. 30(a), if prediction angle information is transmitted only in the first 45-degree area, it may be configured as in Equation 9.

ExplicitDirHorFlag=1,DiffDispVal[0]=[3,4,4,5,6,5,3,2]

ExplicitDirVerFlag=0,DiffDispVal[1]=[ ] [Equation 9]

That is, through such configuration, prediction modes may be weighted in the diagonal direction only in the horizontal area, and only the angle interval of the horizontal area may be transmitted.

In another embodiment, as in FIG. 30(b), if prediction angle information is transmitted both in the horizontal/vertical areas, it may be configured as in Equation 10.

ExplicitDirHorFlag=1,DiffDispVal[0]=[3,4,4,5,6,5,3,2]

ExplicitDirVerFlag=1,DiffDispVal[1]=[3,3,3,7,7,3,3,3] [Equation 10]

That is, through such configuration, prediction modes may be weighted in the diagonal direction in the horizontal area, and prediction modes may be weighted in the diagonal direction and the vertical direction in the vertical area. Furthermore, the angle interval of the horizontal area and the angle interval of the vertical area may be transmitted.

Meanwhile, the angle transmission flag may be defined in at least one level of a sequence parameter set, a picture parameter set, a slice, a block and a coding unit.

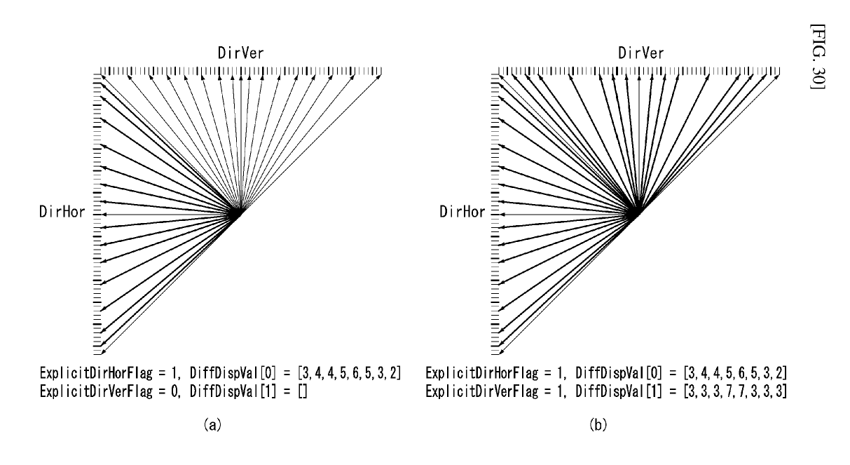

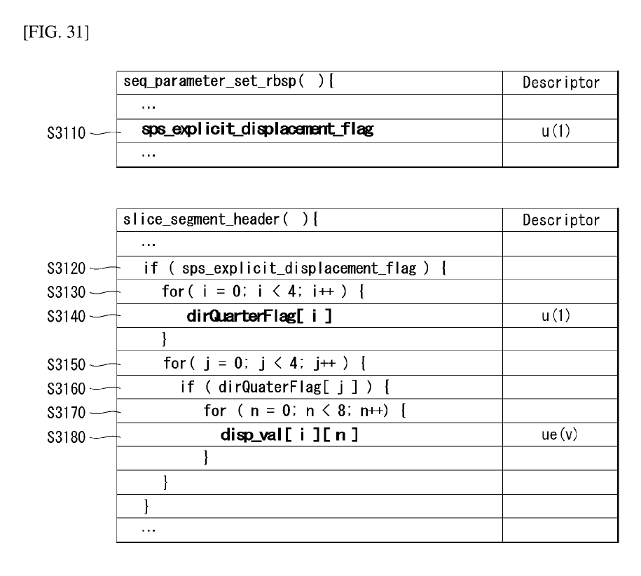

FIG. 31 is an embodiment to which the present invention is applied and is a syntax that defines a method of explicitly transmitting interval information between angle parameters.

The present invention can define an angle transmission flag in a specific area unit and perform adaptive intra-prediction by transmitting at least one of an angle interval and an angle parameter in the specific area unit.

In this case, the angle transmission flag indicates whether prediction angle information is transmitted or not. The prediction angle information is information indicating an intra-prediction direction and may include at least one of the angle interval and the angle parameter. Furthermore, if the flip of a prediction angle is performed, the prediction angle information may include at least one of a flipped angle interval and a flipped angle parameter.

Meanwhile, the angle transmission flag may be defined in at least one level of a sequence parameter set, a picture parameter set, a slice, a block and a coding unit. For example, if the angle transmission flag is defined in the sequence parameter set, the angle transmission flag may be expressed as sps_explicit_displacement_flag.

The sps_explicit_displacement_flag may also be called a sequence angle transmission flag. The sequence angle transmission flag may mean whether the prediction angle information is transmitted in a sequence level (S3110). Alternatively, the sequence angle transmission flag may mean whether a sequence has explicit prediction direction information. Alternatively, the sequence angle transmission flag may mean whether a sequence has explicit intra-prediction direction information.

If the sps_explicit_displacement_flag=1, it indicates that the prediction angle information is transmitted in the sequence level. If the sps_explicit_displacement_flag=0, it indicates that the prediction angle information is not transmitted in the sequence level. Furthermore, if the sps_explicit_displacement_flag is not present, it may mean that a sequence does not transmit the prediction angle information.

For another example, the angle transmission flag defined in the slice may be defined as slice_explicit_displacement_flag. In this case, the slice_explicit_displacement_flag may be dependent on an angle transmission flag on the upper level. For example, if sps_explicit_displacement_flag is 1 in the sequence parameter set, it may be defined as slice_explicit_displacement_flag.

The angle transmission flag defined in the slice may be defined in a 45-degree area unit. For example, an angle transmission flag indicating whether prediction angle information is transmitted in a 45-degree area may be called dirQuarterFlag[i] (i=0, 1, 2, 3) (S3140). The angle transmission flag in the 45-degree area unit is called a quarter angle transmission flag. For example, the quarter angle transmission flag may indicate whether prediction angle information is transmitted or not if intra-prediction modes are 2˜9, 10˜17, 18˜25 and 26˜33.

If the sps_explicit_displacement_flag=1 (S3120), a quarter angle transmission flag “dirQuarterFlag[i]” corresponding to i=0,1,2,3 in a slice header may be obtained (S3130, S3140).

Furthermore, prediction angle information may be obtained based on the quarter angle transmission flag “dirQuarterFlag[i].” In this case, the prediction angle information is information indicating an intra-prediction direction and may include at least one of an angle interval and an angle parameter.

For example, if the quarter angle transmission flag “dirQuarterFlag[i]” is 1 (S3150, S3160), an angle interval corresponding to n=0, 1, 2, 3, 4, 5, 6, 7 may be obtained (S3170, S3180). The angle interval may be expressed as disp_val[i][n]. In this case, n may be defined as 8 if 8 prediction modes are present within a 45-degree interval, but the present invention is not limited thereto. The n may be variable based on the number of prediction modes. Furthermore, the sum of the disp_val[i][n] values may mean precision and may be 32, for example, in the present embodiment.

In an embodiment of the present invention, a prediction direction position in a 45-degree area may be obtained as in Equation 11 below.

[Equation 11]

```
DispVal[i][0] = disp_val [i][0]
for(j = 1; j < 8; j++)
{
    DispVal[i][j] = 0
    for(k = 0; k < j; k++)
      DispVal[i][j] += disp_val[i][k]
}
```

In Equation 11, DispVal[i][j] indicates a prediction direction position in a 45-degree area, and disp_val[i][n] indicates the angle interval between prediction modes.

Referring to Equation 11, the prediction direction position in the 45-degree area starts from 0, and a subsequent prediction direction position may be aware by adding the obtained angle interval disp_val[i][n].

For another example, if the flip of a prediction angle is performed, the prediction angle information may include at least one of a flipped angle interval and a flipped angle parameter.

Another embodiment of the present invention provides a method of obtaining a prediction sample based on an angle transmission flag.

First, assuming that an angle interval parameter is iDispValldx, iDispValldx may be set as in Equation 12 below.

iDispValldx=((predIntraMode−2)% 8)−1 [Equation 12]

If an angle transmission flag is 1 and iDispValldx is greater than 0, an angle parameter “intraPredAngle” may be defined as follows.

1. ildx may be set as ((predIntraMode−2)/8). In this case, ildx indicates a 45-degree area corresponding to an intra-prediction mode and may be set as in Equation 13 below.

ildx=function1(intraPredMode) [Equation 13]

For example, if intra-prediction modes are 2˜9, it may indicate ildx=0. If the intra-prediction modes are 10˜17, it may indicate ildx=1. If the intra-prediction modes are 18˜25, it may indicate ildx=2. If the intra-prediction modes are 26˜34, it may indicate ildx=3.

2. If the quarter angle transmission flag “dirQuarterFlag[i]” is 1, the angle parameter “intraPredAngle” and the inverse angle parameter “invAngle” may be derived as follows.

(i) If ildx % 2 is 0, iDispValldx may be set as (8−iDispValldx−2).

(ii) The angle parameter “intraPredAngle” may be set as (signValue*DispVal[ildx][iDispValldx]).

(iii) If signValue is smaller than 0, an inverse angle parameter “invAngle” may be set as (256*32/intraPredAngle).

In this case, Table 4 shows a mapping table between ildx and startValue, and Table 5 shows a mapping table between ildx and signtValue.

TABLE 4

| | ildx | | | |
|---|---|---|---|---|
| | 0 | 1 | 2 | 3 |
| startValue | 32 | 0 | −32 | 0 |

TABLE 5

| | ildx | | | |
|---|---|---|---|---|
| | 0 | 1 | 2 | 3 |
| signtValue | 1 | −1 | −1 | 1 |

As described above, the decoder may derive at least one of the angle parameter “intraPredAngle” and the inverse angle parameter “invAngle” based on the angle transmission flag. Furthermore, the decoder may generate a prediction sample based on at least one of the derived angle parameter “intraPredAngle” and the derived inverse angle parameter “invAngle.”

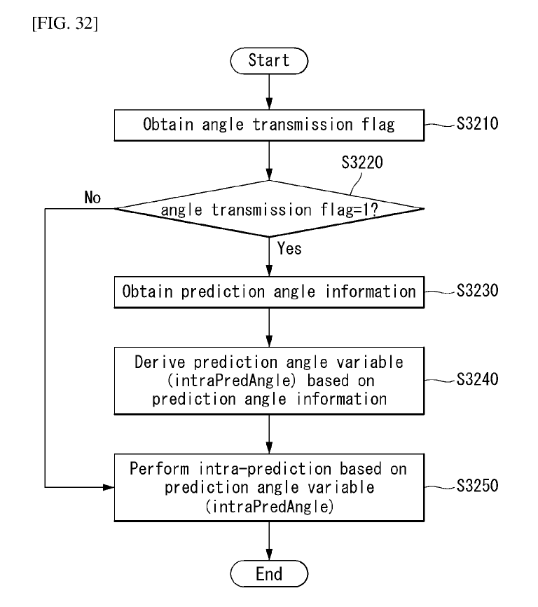

FIG. 32 is an embodiment to which the present invention is applied and is a flowchart illustrating a process of performing intra-prediction based on an angle transmission flag.

The present invention can define an angle transmission flag in a specific area unit and perform adaptive intra-prediction by transmitting at least one of an angle interval and an angle parameter in the specific area unit.

First, the decoder may obtain an angle transmission flag from a received video signal (S3210). In this case, the angle transmission flag indicates whether prediction angle information is transmitted or not. The prediction angle information is information indicating an intra-prediction direction and may include at least one of the angle interval and the angle parameter.

For another example, if the flip of a prediction angle is performed, the prediction angle information may include at least one of a flipped angle interval and a flipped angle parameter.

The angle transmission flag may be defined in at least one level of a sequence parameter set, a picture parameter set, a slice, a block and a coding unit.

Furthermore, the decoder may check whether the angle transmission flag is 1 (S3220).

If, as a result of the check, the angle transmission flag is 1, the decoder may obtain the prediction angle information (S3230). In contrast, if the angle transmission flag is 0, the decoder does not obtain separate prediction angle information and may perform intra-prediction based on an angle parameter “intraPredAngle.”

The decoder may derive at least one of the angle parameter “intraPredAngle” and an inverse prediction angle “invAngle” based on the prediction angle information (S3240).

The decoder may perform intra-prediction based on at least one of the derived angle parameter “intraPredAngle” and the inverse prediction angle “invAngle” (S3250).

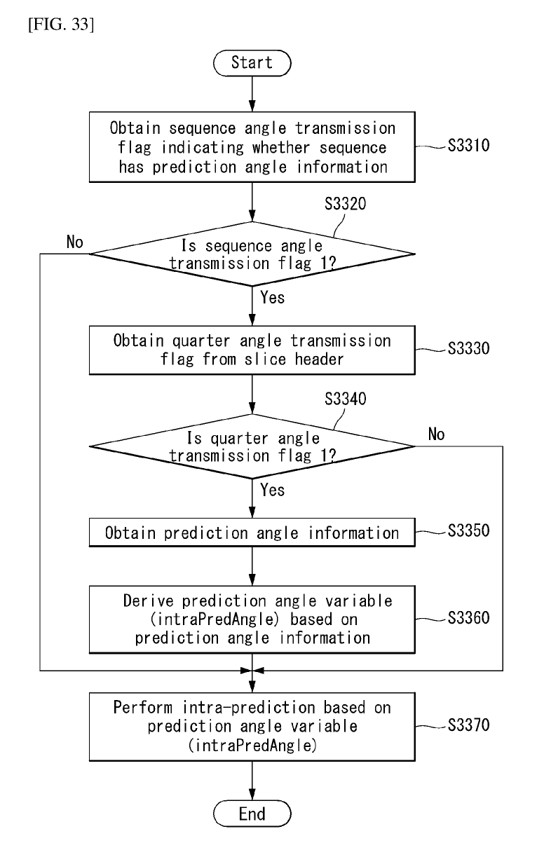

FIG. 33 is an embodiment to which the present invention is applied and is a flowchart illustrating a process of performing intra-prediction using interval information between angle parameters.

First, the decoder may obtain a sequence angle transmission flag “sps_explicit_displacement_flag” from a sequence parameter set (S3310). In this case, the sequence angle transmission flag may mean whether a sequence has prediction angle information. For example, if the sps_explicit_displacement_flag=1, it indicates that a sequence has prediction angle information in a sequence level. If the sps_explicit_displacement_flag=0, it indicates that a sequence does not have prediction angle information in a sequence level.

The decoder may check whether the sequence angle transmission flag “sps_explicit_displacement_flag” is 1 (S3320).

If the sequence angle transmission flag “sps_explicit_displacement_flag” is 1, the decoder may obtain a quarter angle transmission flag “dirQuarterFlag[i]” and prediction angle information from a slice header (S3330). In this case, the quarter angle transmission flag indicates whether prediction angle information is transmitted or not in a 45-degree area. For example, if intra-prediction modes are 2˜9, 10˜17, 18˜25 and 26˜33, the quarter angle transmission flag may indicate whether prediction angle information is transmitted or not.

The prediction angle information may be obtained based on the quarter angle transmission flag “dirQuarterFlag[i].” In this case, the prediction angle information is information indicating an intra-prediction direction and may include at least one of an angle interval and an angle parameter.

The decoder may check whether the quarter angle transmission flag “dirQuarterFlag[i]” is 1 (S3340).

If the quarter angle transmission flag “dirQuarterFlag[i]” is 1, the decoder may obtain the prediction angle information (S3350). For example, if the quarter angle transmission flag “dirQuarterFlag[i]” is 1, the decoder may obtain an angle interval corresponding to n=0, 1, 2, 3, 4, 5, 6, 7.

Meanwhile, if the quarter angle transmission flag is 0, the decoder does not obtain separate prediction angle information and may perform intra-prediction based on an angle parameter “intraPredAngle.”

The decoder may derive at least one of an angle parameter “intraPredAngle” and an inverse prediction angle “invAngle” based on the prediction angle information (S3360).

The decoder may perform intra-prediction based on at least one of the derived angle parameter “intraPredAngle” and the derived inverse prediction angle “invAngle” (S3370).

In the present embodiment, a sequence angle transmission flag and a quarter angle transmission flag of a slice level have been illustrated as being examples, but the present invention is not limited thereto. The sequence angle transmission flag and the quarter angle transmission flag may be described using terms, such as a first angle transmission flag and a second angle transmission flag. In this case, the second angle transmission flag may mean whether prediction angle information is transmitted or not in a lower level than the first angle transmission flag. For example, if the sequence angle transmission flag is defined as the first angle transmission flag, the second angle transmission flag may mean whether prediction angle information is transmitted or not in a slice level when intra-prediction is performed. As described above, the first, the second, the third angle transmission flag, etc. may be used at least one level of a sequence parameter set, a picture parameter set, a slice, a block and a prediction unit.

FIG. 34 is an embodiment to which the present invention is applied and is a diagram for illustrating a method of setting intra angular prediction modes to have a non-uniform interval.

The present invention provides a method of generating a non-uniform intra-prediction mode.

In an embodiment of the present invention, a new prediction direction may be added to an intra-prediction mode and the newly added prediction direction may be non-uniformly generated.

As resolution and complexity of video increase, it is necessary to further increase the precision of an intra-prediction direction. Accordingly, in an embodiment of the present invention, 8 specific angles are selected based on 1/32 precision. In this case, the angles are non-uniformly selected in order to increase prediction precision.

In general, since video has strong vertical and horizontal characteristics, angles are densely selected near the verticality and horizontality and are rarely selected as they become distant from the verticality and horizontality.

FIG. 34(a) shows that 8 angles (0, 2, 5, 9, 13, 17, 21, 26, 32) have been selected based on 1/32 precision, and FIG. 34(b) shows that 16 angles have been non-uniformly selected based on 1/32 precision.

In prediction directions non-uniformly selected in FIG. 34(b), angles are densely selected near 0, that is, a vertical or horizontal direction and are rarely selected as they become distant from the vertical or horizontal direction.

In another embodiment, in order to select an angle, various types of precision, such as 1/64 precision or 1/128 precision, may be used.

In another embodiment to which the present invention is applied, if 17 angles are selected based on 1/32 precision, prediction modes used for intra-prediction encoding are a total of 67 types (2 non-directional modes and 65 directional modes). If many directions are applied to a small PU block, such as a 4×4 block, as described above, encoding performance may be deteriorated because many bits are wasted to encode mode information.

Accordingly, the present invention proposes a method of using 35 directions in a 4×4 PU block and extended 67 directions in the remaining PU blocks. That is, 5 bits are used to encode a prediction mode in the 4×4 PU block, and 6 bits are used to encode a prediction mode in the remaining PU blocks.

In another embodiment, whether how many prediction modes will be used in intra-prediction encoding may be variably determined based on the size of a PU block.

As described above, the embodiments described in the present invention may be performed by being implemented on a processor, a microprocessor, a controller or a chip. For example, the functional units depicted in FIG. 1, FIG. 2, FIG. 10 and FIG. 11 may be performed by being implemented on a computer, a processor, a microprocessor, a controller or a chip.

As described above, the decoder and the encoder to which the present invention is applied may be included in a multimedia broadcasting transmission/reception apparatus, a mobile communication terminal, a home cinema video apparatus, a digital cinema video apparatus, a surveillance camera, a video chatting apparatus, a real-time communication apparatus, such as video communication, a mobile streaming apparatus, a storage medium, a camcorder, a VoD service providing apparatus, an Internet streaming service providing apparatus, a three-dimensional 3D video apparatus, a teleconference video apparatus, and a medical video apparatus and may be used to code video signals and data signals.

Furthermore, the decoding/encoding method to which the present invention is applied may be produced in the form of a program that is to be executed by a computer and may be stored in a computer-readable recording medium. Multimedia data having a data structure according to the present invention may also be stored in computer-readable recording media. The computer-readable recording media include all types of storage devices in which data readable by a computer system is stored. The computer-readable recording media may include a BD, a USB, ROM, RAM, CD-ROM, a magnetic tape, a floppy disk, and an optical data storage device, for example. Furthermore, the computer-readable recording media includes media implemented in the form of carrier waves, e.g., transmission through the Internet. Furthermore, a bit stream generated by the encoding method may be stored in a computer-readable recording medium or may be transmitted over wired/wireless communication networks.

### INDUSTRIAL APPLICABILITY

The exemplary embodiments of the present invention have been disclosed for illustrative purposes, and those skilled in the art may improve, change, replace, or add various other embodiments within the technical spirit and scope of the present invention disclosed in the attached claims

1. A method of decoding a video signal, comprising:
obtaining, from the video signal, a flip flag indicating whether a flip of an angle interval is performed when intra-prediction is performed;
deriving a flip angle variable based on an intra-prediction mode if the flip of the angle interval is performed according to the flip flag when an intra-prediction is performed; and
generating an intra-prediction sample based on the flip angle variable,
wherein the angle interval represents an interval between angle parameters indicating a prediction direction.

2. The method of claim 1,
wherein the flip angle variable corresponds to an angle parameter, and
wherein the angle parameter indicates a value being set according to the intra-prediction mode.

3. The method of claim 1,
wherein the flip flag is set in a specific area unit, and
wherein the specific area unit indicates a horizontal/vertical area or a 45-degree area.

4. The method of claim 1,
wherein the flip flag is obtained from at least one of a sequence parameter set, a picture parameter set, a slice, a block, a coding unit and a prediction unit.

5. A method of decoding a video signal, comprising steps of:
obtaining an angle transmission flag indicating whether the video signal includes prediction angle information indicating an intra-prediction direction;
obtaining prediction angle information when the video signal includes the prediction angle information according to the angle transmission flag;
deriving an angle parameter based on the prediction angle information; and
generating an intra-prediction sample based on the angle parameter,
wherein the prediction angle information comprises at least one of an angle interval and an angle parameter, and
wherein the angle interval indicates an interval between angle parameters which indicate a prediction direction.

6. The method of claim 5,
wherein the angle transmission flag is set in a specific area unit, and
wherein the specific area unit indicates a horizontal/vertical area or a 45-degree area.

7. The method of claim 6,
wherein when the angle transmission flag has been set in a horizontal/vertical area unit, the angle transmission flag is obtained with respect to both the horizontal area and the vertical area, and
wherein the prediction angle information is obtained with respect to at least one of the horizontal area and the vertical area based on the angle transmission flag.

8. The method of claim 5,
wherein the angle transmission flag is obtained from at least one of a sequence parameter set, a picture parameter set, a slice, a block, a coding unit and a prediction unit.

9. The method of claim 5, wherein the prediction angle information is a value at which flip has been performed on the angle interval or the angle parameter.

10. An apparatus for decoding a video signal, comprising:
a parsing unit configured to obtain a flip flag indicating whether a flip of an angle interval is performed when intra-prediction is performed from the video signal; and
an intra-prediction unit configured to derive a flip angle variable based on an intra-prediction mode if a flip of an angle interval is performed according to the flip flag when intra-prediction is performed, and generate an intra-prediction sample based on the flip angle variable,
wherein the angle interval indicates an interval between angle parameters which indicate a prediction direction.

11. The apparatus of claim 10,
wherein the flip angle variable corresponds to the angle parameter, and
wherein the angle parameter indicates a value being set based on the intra-prediction mode.

12. The apparatus of claim 10,
wherein the flip flag is set in a specific area unit, and
wherein the specific area unit indicates a horizontal/vertical area or a 45-degree area.

13. An apparatus for decoding a video signal, comprising:
a parsing unit configured to obtain an angle transmission flag indicating whether the video signal comprises prediction angle information indicating an intra-prediction direction; and
an intra-prediction unit configured to obtain prediction angle information when the video signal includes the prediction angle information according to the angle transmission flag, derive an angle parameter based on the prediction angle information, and generate an intra-prediction sample based on the angle parameter,
wherein the prediction angle information includes at least one of an angle interval and an angle parameter, and
wherein the angle interval indicates an interval between angle parameters which indicate a prediction direction.

14. The apparatus of claim 13,
wherein the angle transmission flag is set in a specific area unit, and
wherein the specific area unit indicates a horizontal/vertical area or a 45-degree area.

15. The apparatus of claim 14,
wherein when the angle transmission flag has been set in a horizontal/vertical area unit, the angle transmission flag is obtained with respect to both the horizontal area and the vertical area, and
wherein the prediction angle information is obtained with respect to at least one of the horizontal area and the vertical area based on the angle transmission flag.
